(19) United States
(12) Patent Application Publication
(10) Pub. No.: US 2024/0430398 A1
(43) Pub. Date: Dec. 26, 2024

(54) AUTOSTEREOSCOPIC LCD DISPLAY

(71) Applicant: REALFICTION LAB APS, Copenhagen K (DK)

(72) Inventor: Steen Svendstorp Krener-Iversen, Copenhagen K (DK)

(73) Assignee: REALFICTION LAB APS, Copenhagen K (DK)

(21) Appl. No.: 18/708,024

(22) PCT Filed: Nov. 8, 2022
(86) PCT No.: PCT/EP2022/080443

§ 371 Date: May 7, 2024

(30) Foreign Application Priority Data
Nov. 8, 2021 (EP) 21206965.2
Jul. 22, 2022 (EP) 22186473.9

(51) Int. Cl. H04N 13/32; G09G 3/36; H04N 13/383

(52) U.S. Cl. CPC H04N 13/32; G09G 3/36; H04N 13/383; G09G 2354/00

(57) ABSTRACT

A time-division multiplexed autostereoscopic display preferably having a spatial light modulator layer comprising liquid crystals for modulating light emitted from a directional backlight. The display allows for a plurality of observers to observe images in 3D as well as updating the display for a moving observer.

The present invention relates to a time-division multiplexed autostereoscopic display preferably having a spatial light modulator layer comprising liquid crystals for modulating light emitted from a directional backlight.

In US 2020/118476 a display apparatus and a method of driving a display panel using the display apparatus is disclosed. WO 2018/035045 discloses a display with variable resolution, and KR 102100246 disclose a display apparatus.

It is an object of the present invention to minimize the appearance of artifacts such as ghost images seen when moving, for example when the observer changes position or when a dark image is followed by a bright image.

A first aspect of the present disclosure is:

A method for displaying a stereoscopic image to a moving observer, said method comprising:
providing a time-division multiplexed autostereoscopic display comprising
a spatial light modulator layer,
said spatial light modulator layer comprising a plurality of light modulators, each light modulator constituting a respective image pixel of said display,
a plurality of optical elements,
said plurality of optical elements arranged such that a respective optical element being behind an image pixel of said display,
each optical element having an optical power,
a backlight,
said backlight comprising a plurality of arrays of light emitters,
said plurality of arrays of light emitters arranged such that a respective array of light emitters being behind an optical element,
providing a tracking system for determining said observer position, and determining a first position of said observer by means of said tracking system, and displaying a first image to the right eye and a second image to the left eye of said observer at said first position by means of said time-division multiplexed autostereoscopic display,
a respective image pixel having a first pixel value when displaying said first image,
tracking the position of said observer by means of said tracking system,
each light modulator having a response time of no more than 2 ms such that when said observer having moved to a second position:
displaying a third image to the right eye and a fourth image to the left eye of said observer at said second position by means of said time-division multiplexed autostereoscopic display,
said respective image pixel having a second pixel value when displaying said third image,
said second pixel value reached within a time window, said time window being 4 ms,
said first pixel value defining a first light transmission percentage of a maximum light transmission,
said second pixel value defining a second light transmission percentage of a maximum light transmission,
said second light transmission percentage being more than 60 percentage points different from said first light transmission percentage,
said second pixel value reached within said time window when said second pixel value being greater than said first pixel value and when said second pixel value being smaller than said first pixel value.

Thus, the display can update both when transitioning from a dark image to a bright image and vice versa, i.e. the transitioning from a first image to a second image for the eye of the observer may be performed within a time window of 2 ms when the change in pixel value is more than 60% points both when the transmission is increased and decreased. Where a change in pixel value is the change in transmission in percentage of the maximum transmission for that pixel. The system can also change pixel value within a time window of 2 ms for lower changes in pixel value than 60% points, but this is to illustrate that the system has the technical feature that it can increase or decrease a pixel value by more than 60% points within a time window of 2 ms no matter the content of the image, i.e. the transitioning happens in the required time for any pixel value, i.e. from an arbitrary pixel value to an arbitrary pixel value.

If two images are to be sent to an observer, one pixel needs to change value to a first pixel value for the first image sent towards a first eye, this change can be done in maximum 2 ms. Then the pixel can change value so a second pixel value can be sent towards a second eye of an observer within 2 ms counted from when the first pixel value has been updated. Next a third image can be sent towards the first eye of an observer within the next 2 ms by changing the pixel value to a third pixel value. A fourth image can be sent to the second eye of an observer by changing the pixel value to a fourth pixel value. Thus if we count the time after the first pixel value have been updated until the third pixel value has been updated this is 4 ms or less.

Thus, no matter the content of the image, the transitioning from one image to the next happens in the required time for any pixel value such that the (3D) display can keep up with the movement of the observer, i.e. from an arbitrary pixel value to an arbitrary pixel value (dark to bright or bright to dark). For non 3D displays this is not necessary, because the image from a non 3D display is not directional, i.e. the same image can be seen anywhere in front of the display while for the 3D display it sends a pair of images to the eyes of the observer so that the observer at a given position sees a right image for the right eye and a left image for the left eye, and when the observer moves the observer still see a right image for the right eye and the left image for the left eye and not a right image for the left eye.

The display may be an active matrix thin-film-transistor liquid-crystal display.

Time-division multiplexing (TDM) is a method of transmitting and receiving independent signals over a common signal path by means of synchronized switches at each end of the transmission line so that each signal appears on the line only a fraction of time in an alternating pattern. This method transmits two or more digital signals or analog signals over a common channel.

A spatial light modulator layer may be a layer of liquid crystal cells.

The display has a plurality of image pixels for generating the image, i.e. each image pixel displayes a pixel of the image.

The image pixels may be addressed in rows and columns with a pixel driver at each intersection between a row wire and a column wire (the row wire may be termed a scan line and the column wire may be termed a dataline). The pixel driver may be transistor. The (electric) circuit with all of the wires and pixel drivers may be implemented in a thin film behind the layer of image pixels (in the backplane).

A problem with LCD displays is that, if there over several minutes is a too big time-integrated electrical DC offset over a pixel cell, the cell may be temporarily or permanently damaged.

In a traditional display, this may be overcome by a polarity inversion after each frame, i.e. reversing the electrical polarity over LC pixel cells for each subsequent frame displayed. This is possible because a pixel cell in a traditional LCD display may respond to the magnitude of the electrical field only and essentially not to the polarity. In other words, the pixel cells respond essentially to the numerical value of the electrical field. This polarity inversion reduces the time integrated DC potential over LC cells over a longer interval, for example tens of seconds, significantly, hence damage to the display is avoided. The assumption behind this idea is that the difference between two subsequent frames over a longer time period statistically is very little. This assumption holds true for most practical purposes: the difference between a video frame and the next video frame is in most cases small. The same holds for computer content like word processing. Even for time multiplexed stereoscopic 3D content this may hold relatively true.

In the disclosed display however, this assumption may not hold true.

An example: a time division multiplexed stereoscopic display displaying a still image may in one area of the left eye perspective image, for example an area comprising a tree on a bright background, be significantly darker than the corresponding area in the right eye perspective image, which due to the sterescopic parallax may comprise bright background. This means that pixels in said area alternates between dark and bright values for a long period of time, and the time-integrated electrical DC offset over pixel cells in the areas may be large enough to damage the display.

Another example: a time division multiplexed multiview display in a car may display a dimly lit navigation image to the driver and a brightly lit entertainment image to the passenger such as a movie or a game, likewise causing DC offsets large enough to damage pixel cells.

A second aspect of the present disclosure is therefore:

A method for minimizing an offset DC voltage across a liquid-crystal pixel cell over time in an auto-stereoscopic or multi-view display, said method comprising:
providing said auto-stereoscopic or multi-view display,
displaying a first image by means of said auto-stereoscopic or multi-view display at a first viewing region,
displaying a second image by means of said auto-stereoscopic or multi-view display at a second viewing region,
said auto-stereoscopic or multi-view display having a voltage across said liquid-crystal pixel cell with a first polarity when said first image and said second image being displayed,
displaying a third image by means of said auto-stereoscopic or multi-view display at said first viewing region,
displaying a fourth image by means of said auto-stereoscopic or multi-view display at said second viewing region,
said auto-stereoscopic or multi-view display having a voltage across said liquid-crystal pixel cell with a second polarity when said third image and said fourth image being displayed, said first polarity being different from said second polarity.

Thus, the solution above is to perform an electrical polarity inversion not after each frame is displayed, but after a full multiplexing cycle has been completed and all images intended for different eyes or observers have been displayed. Since each subsequent frame of each of the views will have the same statistical small difference as subsequent frames in a traditional display, an operation like this may result in a time-integrated DC offset, which is small enough to not cause any damage to pixel cells.

The liquid-crystal pixel cell may generate the image together with the other liquid-crystal pixel cells by modulating light from a light source behind the liquid-crystal pixel cells. The liquid-crystal pixel cells may be sandwiched between a pair of electrodes typically implemented as glass substrate layers.

A viewing region may be the size of an eye or it may be as large as the face of an observer. There may be only two viewing zones such that one viewing zone is to the right of the normal vector to the display surface and the other is to the left of the normal vector to the display surface, such a use case may for example be the infotainment screen in an automobile.

The images are time-multiplexed, i.e. displayed sequentially. The minimum number of images in a multiplexing cycle is two, i.e. a multiplexing cycle may define the time window in which a pair of two-dimensional images are displayed to the right and left eye of the observer respectively. The two images are then multiplexed by the observer's brain. Or a multiplexing cycle may define the time window in which a first image is displayed to a first observer and a second image is displayed to a second observer. There may be more than two observers and each observer may receive a right eye image and a left eye image.

In a multiplexing cycle the polarity may be the same, i.e. the same polarity for all images displayed in a multiplexing cycle. In the next multiplexing cycle the polarity may be reversed during the whole multiplexing cycle. It may be summarized in the below table:

| Multiplexing | Image/ | Direction/ | Voltage |
|---|---|---|---|
| cycle | frame | angle to display | polarity |
| 1 | 1 | 5 degrees | + |
| 1 | 2 | 15 degrees | + |
| 2 | 3 | 5 degrees | − |
| 2 | 4 | 15 degrees | − |
| 3 | 5 | 5 degrees | + |
| 3 | 6 | 15 degrees | + |
| 4 | 7 | 5 degrees | − |
| 4 | 8 | 15 degrees | − |

The auto-stereoscopic or multi-view display is per definition arranged to direct an image to a viewing region in front of the display so that the image can only be observed in that specific viewing region. In this way a pair of two-dimensional images may be directed to an observer's eyes who perceives a depth in the image, i.e. the display may direct a first image to the position of the right eye of the observer and direct a second image to the position of the left eye of the observer so that each eye sees a different image.

Alternatively, in the situation when the display is functioning as a multi-view 2D display a first observer at a first position in front of the display may see a first 2D image and a second observer at a second position in front of the display may see a second 2D image.

Eye tracking may be used to determine where in space the image is to be directed.

The invention will now be explained in more detail below by means of examples with reference to the accompanying drawings. The invention may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

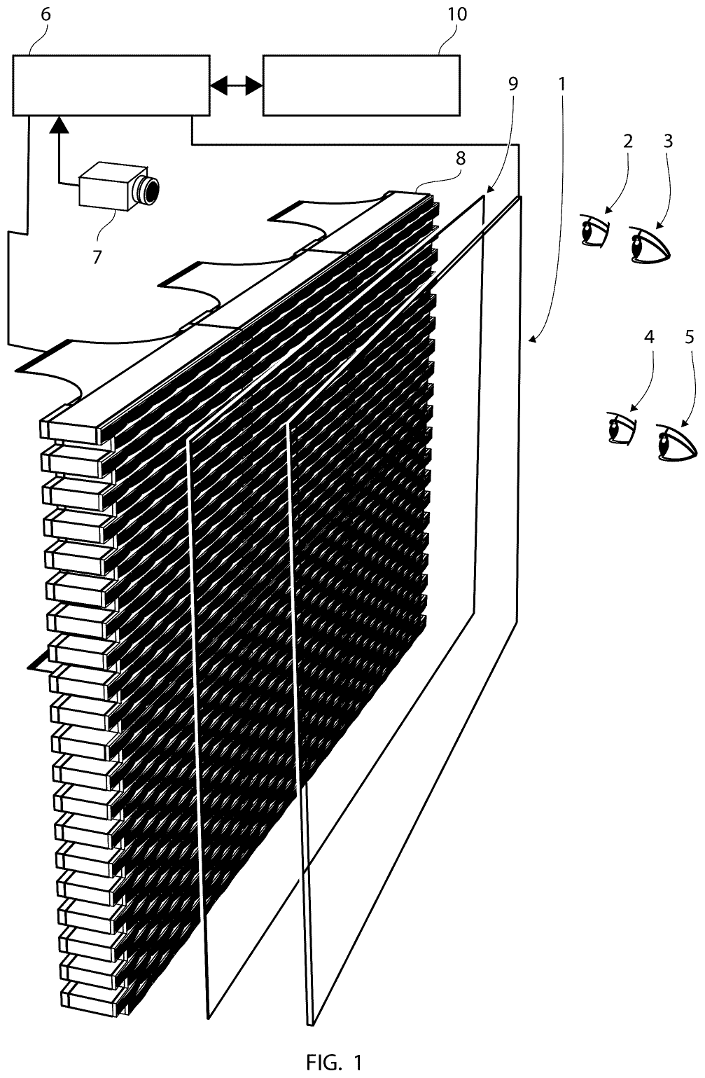

FIG. 1 shows a perspective view of an example of a configuration of the disclosed invention.

A transparent display 1, which may be an LCD display, is observed by a set of eyes which may comprise a first eye 2, a second eye 3, a third eye 4 and a fourth eye 5. The display 1 is connected to a controller 6 and the controller 6 is connected to an eye tracking system 7 which is capable of tracking positions of eyes in the set of eyes. The controller 6 is further connected to a directional backlight 8 and may be capable of receiving a position of a first target eye from the eye tracking system 7 and controlling the backlight 8 so the backlight 8 emits light towards the target eye. The backlight 8 may be configured so it appears illuminated to the first target eye and essentially dark to other eyes in the set of eyes. The controller 6 may further be connected to the display 1 and may receive a first image signal from an image generator 10 and direct the display 1 to display a first image corresponding the first image signal. Hence, since the display 1 is transparent, the first target eye may observe the first image displayed on the display 1 and the other eyes may see the display as being dark. A directional backlight is well known in the art of autostereoscopic displays and may for example have both horizontal and vertical control of emitted light and comprise a large lens, for example a Fresnel lens, configured to focus light from an array of light emitters towards the target eye. Alternatively it may comprise a plurality of smaller lenses and may have only horizontal control of emitted light. A diffuser 9, which may be a vertical-only (elliptical) diffuser may be comprised to increase uniformity of the illumination. In sections further below shall be taught an especially advantageous configuration of the backlight 8 which is shown in FIG. 1.

The controller 6 may be configured to operate in a time division multiplexed way, for example in a cycle comprising two time slots, so in a first time slot it receives a position of the first target eye and receives a first image signal and controls the backlight eye so it emits light towards the first target eye and controls the display so it displays a first image corresponding to the first image signal and so in a second time slot it receives a position of a second target eye and receives a second image signal and controls the backlight eye so it emits light towards the second target eye and controls the display so it displays a second image corresponding to the second image signal.

In this configuration the first target eye may for example be a left eye of a first observer and the second target eye may be a right eye of the first observer and the first image may be a left eye perspective image and the second image may be a right eye perspective image and hence the first observer may observer a stereoscopic image. The image generator 10 may receive eye position information of the first target eye and the second target eye from the eye tracking system 7, for example through the controller 6. The eye position information may be updated regularly or when an eye position change is detected and the image generator 10 may update the first image signal and the second image signal to change perspective views correspondingly, so when the display 1 is updated during the time division multiplexing cycle the first target eye and the second target eye observes updated perspective image corresponding to changes in position. Additionally, the image generator 10 may output image signals updated as a function of time, in other words moving images or video. Hence the first observer may experience that he or she can move relatively to the display 1 and experience updated stereoscopic moving images of objects and scenes with perspectives corresponding to his or her viewpoint updated synchronously to his or her viewpoint. This may result in a very realistic experience of objects and scenes with stereoscopic depth and changing perspectives, an experience sometimes referred to as holographic video.

In an especially advantageous configuration the multiplexing cycle may comprise 4 or more time slots operated in a similar way, so two or more observers can have the experience simultaneously. A problem with this configuration is that the frame rate of the display needs to be N times a desired experienced frame rate, where N is the number of eyes in the set of eyes. The desired experienced frame may be for example 60 frames per second, which may be the minimum frame rate to achieve a comfortable flicker and strobing free experience, hence if the number of observes is two and hence the number of eyes N is 4, then the frame rate of the display needs to be n×4=240 frames per second.

Commercially available transparent displays with 240 frames per second do exist, but a problem is, that liquid crystals used in such display have long response times, resulting in crosstalk (afterglow, afterimages) between successively displayed images, which would result in unacceptable levels of stereoscopic crosstalk in the disclosed invention. A solution to this may be to use ferroelectric liquid crystals which may have much faster response times, for example as described in U.S. Pat. Nos. 9,366,934 or 9,575,366 or 9,946,133 or 10,281,731 or 8,755,022 or 11,015,120 which are hereby included in the description by reference.

However, it may be advantageous that more than two observers can observe the display simultaneously. The controller 10 may adjust the number of time slots in a multiplexing cycle and the frame rate of the display 1 according to a number of observing eyes detected by the eye tracking system 7. For example 6 time slots may allow a group of three people in a living room to experience stereoscopic images with individual perspectives corresponding to their positions relative to the display 1. In this situation the frame rate may be set to 6*60=360 frames per second. For even more observers even higher frame rates are needed. Even when using liquid crystals with very fast response times there is another problem in realizing these frame rates: thin film transistor active matrix pixel addressing circuits used in almost all types of moving image displays including transparent liquid crystal displays start to show severe image artifacts when operated at such high frame rates primarily due to RC time constants in electrode lines, resulting in inadequate charging of capacitors in sample-and-hold circuits in the pixel drivers.

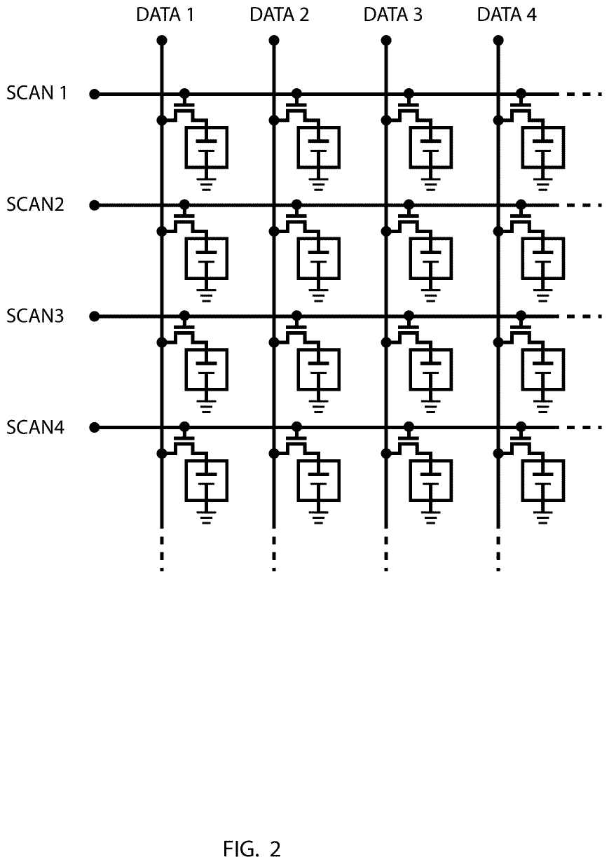

FIG. 2 shows a schematic diagram of a part of a thin film active matrix circuit which may be comprised in a backplane of the transparent display 1.

The shown part comprises 4 data lines and 4 scan lines and at each intersection is located a sample and hold circuit comprising a capacitor and a switch transistor connected to a liquid crystal spatial light modulator constituting a pixel (or a color subpixel). The full thin film active matrix circuit may comprise for example 1920 data lines and 4 scan lines.

The operation of a thin film active matrix circuit is well known in the art of active matrix displays, here shall just be noted that traditionally one row of pixels is updated at a time by a gate driver setting the corresponding scan line active in a scan line period during which a source driver is holding the desired pixel values for that row as analog values on the data lines, so the pixel values are written into sample and hold circuits also called pixel drivers connected to liquid crystal cells. The display 1 is updated with a new image by activating scan lines one at a time during a scan line period while presenting desired pixel values for corresponding rows of pixels. The duration of a scan line period may be limited by the settling time of sample and hold registers. Settling time may vary from one pixel to another, for example a top left pixel located close to both the gate driver and the source driver may have short settling time and a bottom right pixel located farther away from the gate driver and source driver may have a longer settling time due to longer RC time constants in connecting electrode lines. A duration Tscan of a scan line period may be selected to be longer than the settling time of a pixel having the longest settling time of the display 1. The duration Tscan may further be selected so it includes a period during which all scan lines are inactive.

The active matrix thin film circuit may be optimized for high frame rates using known techniques for example including scan lines connected at both ends of the display to the gate driver and data lines connected at both ends to the source driver for reducing RC time constants. Simultaneous scan line driving is another example for optimizing frame rate. Reference is made to U.S. Pat. No. 10,063,877 which is hereby included by reference. However, it may be still difficult to achieve the desired high frame rates with a feasible circuit design. The very fastest active matrix displays with full HD resolution today can operate at up to 360 frames per second.

A solution to this problem may be to use pixel merging where pixel rows are updated in pairs with duplicated values, so that row 1 and 2 are updated simultaneous by holding scan line 1 and scan line 2 high while the data lines are held at a set of calculated row pixel values which is written into both row 1 and 2, and where the set of pixel values is calculated for best visual appearance for example by setting it equal to a set of pixel values corresponding to pixel values in row 1 or by setting it equal to a set of pixels values calculated by taking an average of corresponding pixel values in row 1 and row 2. Hence pixel row 1 and pixel row 2 may be updated with substantially similar equal values. In practice there may be deviations in pixel values due to production tolerances in pixels and pixel drivers. Then row 3 and 4 are updated similarly, then row 5 and row 6 and so on. The total number of scan lines in the display 1 may be set to an even number. Tscan may in this configuration be selected so it is long enough for two capacitors in two sample-and-hold circuits to be charged to within acceptable tolerances. This operation can double the frame rate, since only half the update time is needed, because rows are updated in pairs simultaneously. Hence a display with a nominal maximum frame rate of 360 frames per second can be operated at up to 720 frames per second. A compensation circuit for compensating for production tolerances in pixels and pixel drivers may be included. The compensation circuit may for example comprise a lookup table for compensating pixel values and pixel values in two merged pixel rows may be compensated using a compensation value calculated from entries in the lookup table corresponding to the two merged pixel rows for example by taking an average of pixel values corresponding to a same pixel column.

A problem with this solution, however, is that it reduces the vertical resolution to half the original resolution, which may cause visual degradation of the displayed image in some instances.

The disclosed invention solves this by adaptive pixel merging, comprising the action of selecting a set of row pairs for pixel merging and then pixel merging row pairs in the selected set of row pairs and performing a normal update of the rest of the pixel rows.

The set of row pairs may be selected so the visual impact of the pixel merging is minimized. In one example the set of row pairs may be selected by selecting row pairs outside one or more area(s) of interest. The area(s) of interest may be one or more areas stretching horizontally from the left edge to the right edge of the display 1. The selection of row pairs outside the area(s) of interest may comprise selecting consecutive rows from top to bottom outside the area(s) of interest. The area of interest may be selected to be for example a lower part of an image, for example the bottom half. Thus, in an image with a landscape below a horizon and a sky above, and where the sky has fewer high spatial frequencies than the landscape, this may result in a much better perceived image quality than if all line pairs were row merged.

The area(s) of interest may be pre-defined for all images shown on the display 1 or it may be calculated for an image to be displayed using the image signal as input to the calculation. For example the area(s) of interest may be selected by analyzing a set of corresponding areas in an image an selecting (an) area(s) having more high spatial frequencies than other area(s) or selecting an area comprising an object of interest. The object of interest may for example be a face, an eye, a text or another significant object in the image and it may be determined manually or automatically, for example by automated semantic image analysis such as for example face detection.

Alternatively or additionally the set of row pairs may be selected by selecting row pairs having a high similarity between pixels rows in the pair, for example by ranking all possible consecutive row pairs, calculating the sum of differences between pixel values for each possible row pair, ranking row pairs after sum of differences and selecting a set of row pairs by starting with the pair having the lowest sum of differences and moving up in the rank until a fraction of rows are included in the set of row pairs, where the fraction may be for example half of the rows in an image.

Alternatively or additionally to pixel merging of two rows, pixel merging of more than two rows may be performed in similar ways to the above described. I.e. sets of more than two scan lines may be active at a time and sets of more than two rows may be updated essentially simultaneously. In one example, pixel rows having a similarity above a certain similarity threshold may be updated simultaneously. For example a completely black image could have all rows updated simultaneously. In practice it may be necessary to reduce the number of rows being updated simultaneously. The number of selected rows to be updated at a time may be limited to a maximum row number, selected so an update can be performed without the time constant of the resulting RC time constant becomes too large for a satisfactory update of all sample-and-hold circuits.

Sets of row pairs for pixel merging may be selected and sets of calculated row pixel values may be calculated before the image is displayed. For example, an input digital image representation may be analyzed and an output digital image representation to be displayed may be calculated, where the output digital image representation comprises a pixel row with calculated row pixel values for every pair of rows in the input image that has been merged and further calculates and stores a binary value referred to as the Duplicate flag, indicating that the row should be duplicated on two consecutive pixel rows of the display when displayed. (Alternative embodiments may in a similar way merge and store more than two rows and calculate additional flags indicating tripling, quadrupling etc).

Sets of row pairs may be selected so frames in a multiplexing cycle have different number of row pairs merged and so that the total number of merged row pairs in a multiplexing cycle. Thus images for different eyes may be optimized individually for a better overall performance while the total number of scans and hence the total needed for scanning images of a multiplexing cycle may be kept constant and a constant frame rate is experienced by each eye. For example a first image displayed to the first eye 2 and a second image displayed to the second eye 3, where the first eye 2 and the second eye 3 belong to the same observer, and where the first image and the second image constitute a stereoscopic image pair, may be optimized so an area in the first image comprises merged rows and a corresponding area in the second image does not comprise merged rows. Thus update time is saved by pixel merging while detailed image information about homologues areas in the stereoscopic image pair is still delivered to the observer and due to the operation of the human visual system the stereoscopic image may be perceived as having a high quality and the merged rows may be less visible than if rows were merged in corresponding areas in both images.

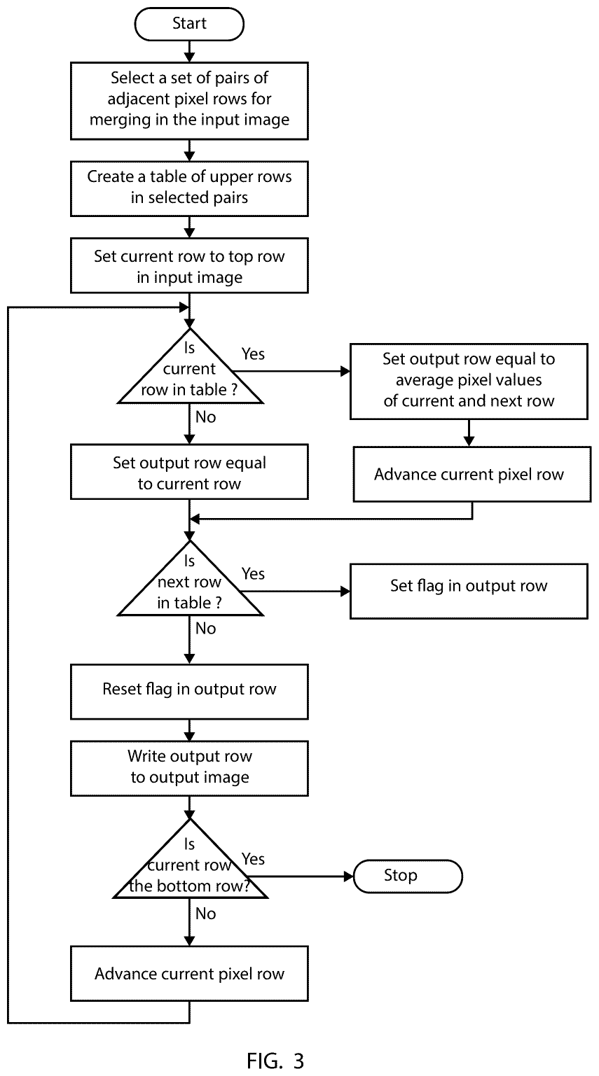

FIG. 3 shows a flow chart describing an example of a method for creating such an output digital image representation from an input digital image representation.

The merge flag indicating if a current row should be duplicated may be stored in a previous row, i.e. stored in the last scanned row before the current row. Hence a gate driver in the display 1 may have time to read the Duplicate flag and shift between duplicating or not duplicating, i.e. between updating pixel rows in pairs or one at a time before advancing to the next scan line. The Duplicate flag may for example be stored in a first pixel value memory in the previous row of the output digital image representation which may be read by a gate driver and the display 1 may omit using the first pixel value memory for displaying a pixel value, i.e. the display may omit displaying a first column of pixels in the output digital image representation.

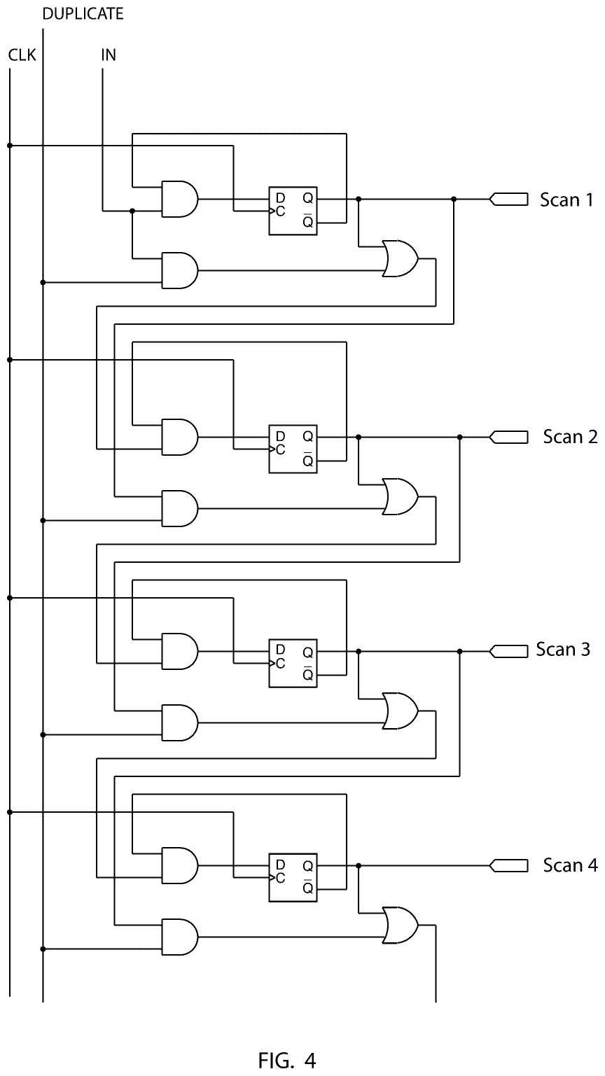

FIG. 4 shows a schematic diagram of an example of an electric circuit for a gate driver (scan line driver) for an active matrix thin film circuit capable of reading and displaying the output digital image representation.

The electrode lines Scan 1-4 are connected to scan lines as shown in FIG. 2.

The input electrode line CLK may be connected to a clock signal controlling the scan sequence of the gate driver.

The input electrode line “Duplicate” may be connected to the electrode line “data 1” in FIG. 2 and the source driver may output the Duplicate flags stored in the first pixel value memory in each row synchronized with the scan lines. In other words, the source driver may operate the line Data 1 as any other data line, but is may be connected to the Duplicate input line and used by the gate driver to switch between duplicating and not-duplicating. Pixels shown in FIG. 2 connected to the data line 1 may be omitted since data line 1 does in this configuration not represent pixel values.

The schematic diagram is shown here with 4 scan lines, in practice it may be extended to many more scan lines by repeating the circuits shown.

Additional circuitry for timing control etc. like setting the “IN” line high after a V-Sync, initializing flip flop registers etc. as is well known in the art may be included.

The gate driver shown has is a very basic operation, other gate driver operation schemes for example comprising charge sharing, intervals between active scan lines and other techniques known in the art of active matrix displays may be used with the addition of scan line duplication controlled by a duplicate signal.

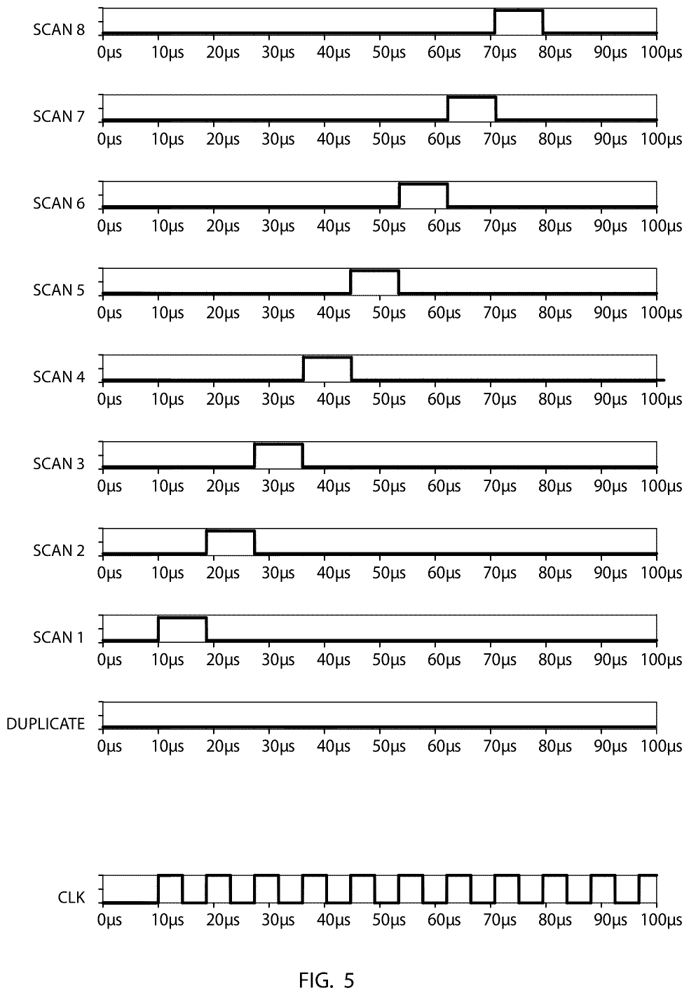

FIG. 5 shows an example of a timing diagram of the inputs CLK and Duplicate and of the outputs Scan 1-8 in the situation where Duplicate is low throughout a scan sequence.

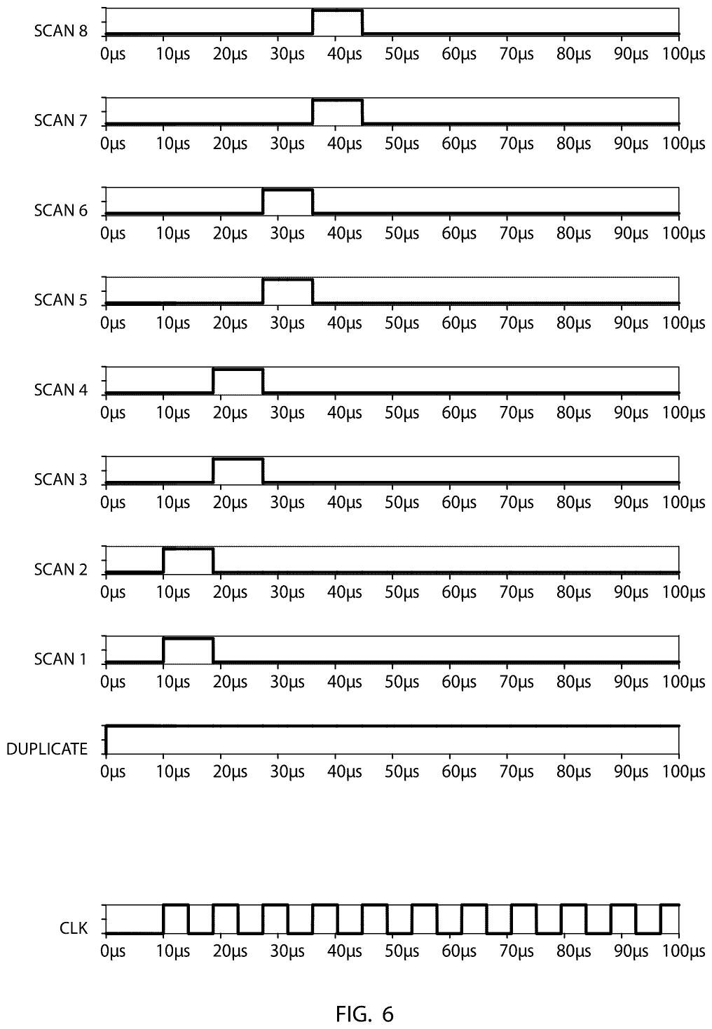

FIG. 6 shows an example of a timing diagram of the inputs CLK and Duplicate and of the outputs Scan 1-8 in the situation where Duplicate is high throughout a scan sequence.

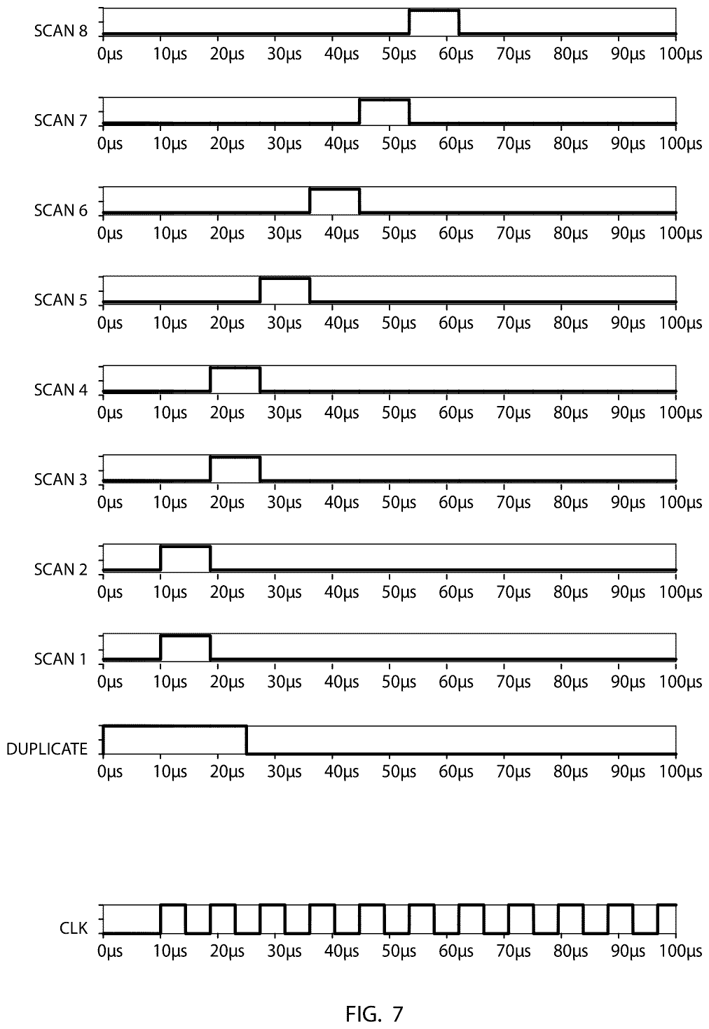

FIG. 7 shows an example of a timing diagram of the inputs CLK and Duplicate and of the outputs Scan 1-8 in the situation where Duplicate is high then goes low during a scan sequence.

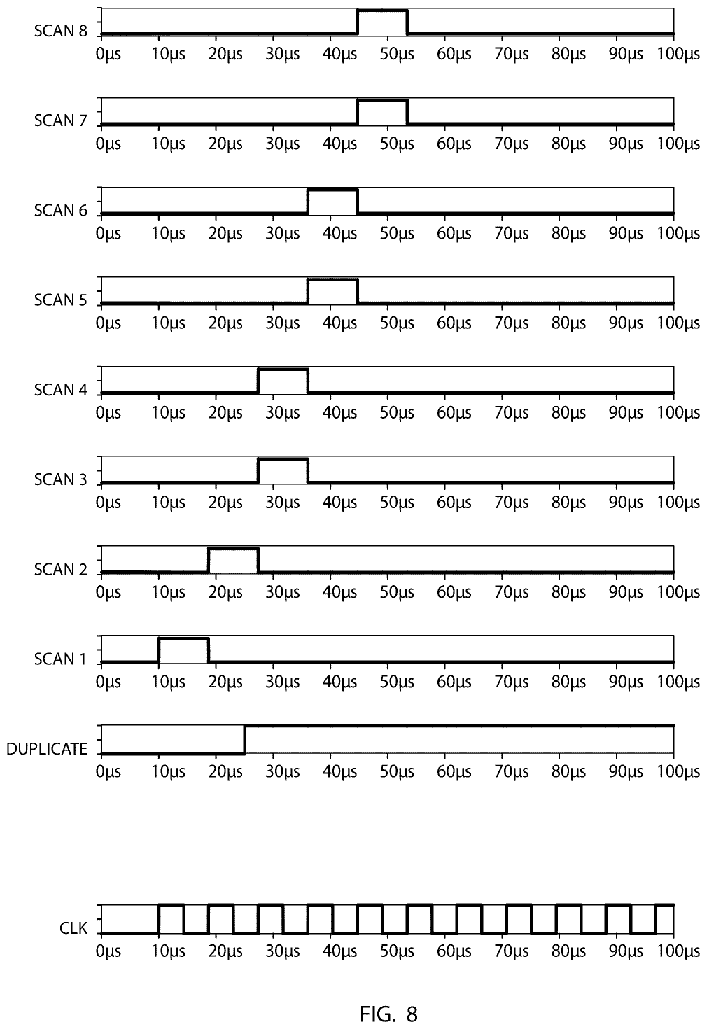

FIG. 8 shows an example of a timing diagram of the inputs CLK and Duplicate and of the outputs Scan 1-8 in the situation where Duplicate is low then goes high during a scan sequence.

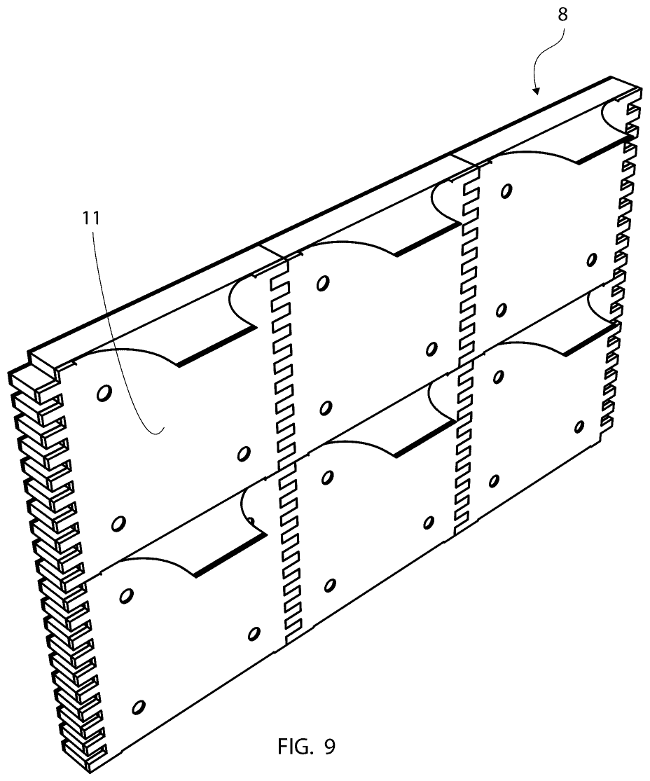

FIG. 9 shows a perspective view of the backside of an example of a configuration of the directional backlight 8, i.e. the side facing the backside of the display, away from an observer.

The backlight 8 may be constructed so it is modular, comprising at least one backlight module 11.

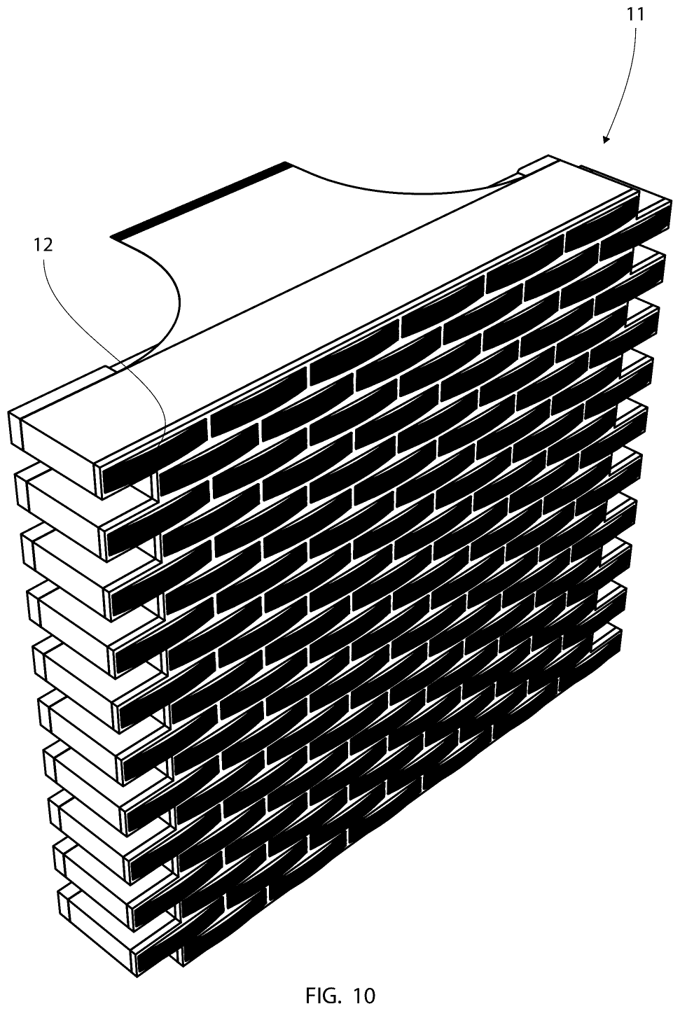

FIG. 10 shows a perspective view of an example of a configuration of the backlight module 11.

The backlight module 11 may comprise a plurality of directional light emitting elements elongated in the horizontal direction and the directional light emitters may be arranged in a staggered pattern similar to the illustrated pattern. A directional light emitting element 12 in the plurality of directional light emitting elements may emit a beam of light having a direction and a beam divergence in a horizontal plane where the direction may be controlled by the controller 6. Further the beam divergence may be controlled by the controller 6.

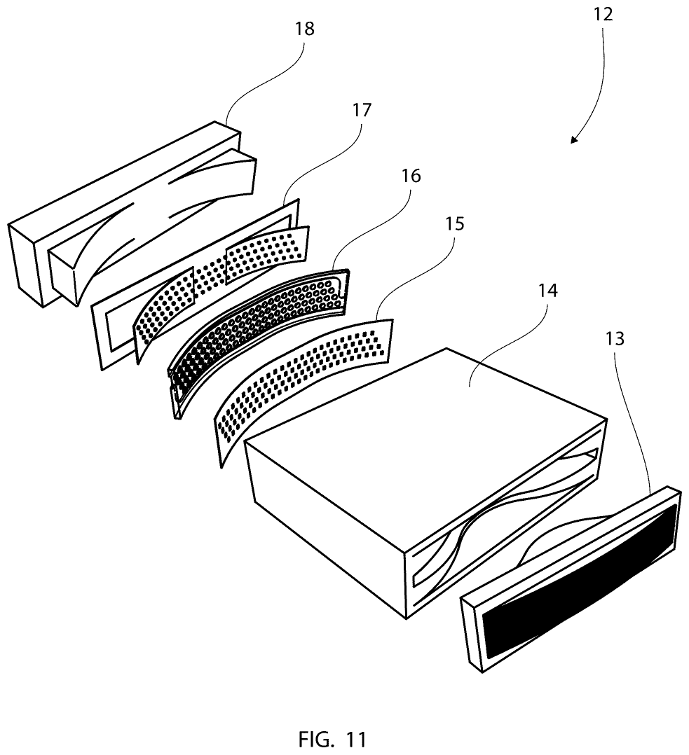

FIG. 11 shows a perspective exploded view of an example of a configuration of the directional light emitting element 12 comprising a lens 13.

The lens may be an element having an optical power in the horizontal direction, for example a cylindrical or acylindrical lens, a spacer 14, a flexible aperture mask 15, a flexible light collection microlens array 16, a flexible array of light emitters 17 and a back support structure 18.

The flexible array of light emitters 17 may be white microLEDs on a flexible thin film transistor backplane for example comprising polyimide. The backplane may have low reflectivity, for example it may be coated with dark paint, as known from the art of microLED displays. The microLEDs may for example be flip chip bonded to the flexible thin film backplane. The flexible light collection microlens array 16 may for example be a molded or embossed polymer sheet, for example comprising PMMA, of plano convex microlenses arranged so a microlens is in front of a microLED and so the microlens focuses light from the microLED towards the lens 13. The flexible aperture mask 15 may be a pattern of black ink or paint on the flat (plano) side of the flexible microlens array 16. The flexible aperture mask 15 may be configured so a horizontal pitch (i.e. a center to center distance along the flexible aperture mask 15) is equal to a width of an aperture opening in the flexible aperture mask 15. The width may for example be 0.25 mm and the height may be 0.4 mm. Hence the pitch of the apertures may also be 0.25 mm. A pitch of microLEDs may be essentially equal to the pitch of the apertures and the pitch of microlenses may be essentially equal to the pitch of the apertures.

The back support structure 18 may have a surface on which a section of the backplane of the flexible array of light emitters 17 rests and which may be curved to follow substantially an image plane field curvature of the lens 13. The section may be separated from the rest of the backplane by punched out cut lines, so when the backsupport structure 18 is mounted and pressed towards the backplane, the section can leave the backplane and follow the curvature of the back support structure 18. Inside the spacer 14 may be located flanges (now shown) which may follow the curvature and hold the flexible array of light emitters 17, the flexibe microlens array 16 and the flexible aperture mask 15 in place towards the backsupport structure 18. The flanges may be located so they touch the flexible aperture mask 15 at the edges without blocking light apertures in reaching the lens 13. The spacer may be configured so a distance from a microLED to the lens 13 is approximately equal to a focal length of the lens 13, hence light from a microLED may be focused by the lens 13.

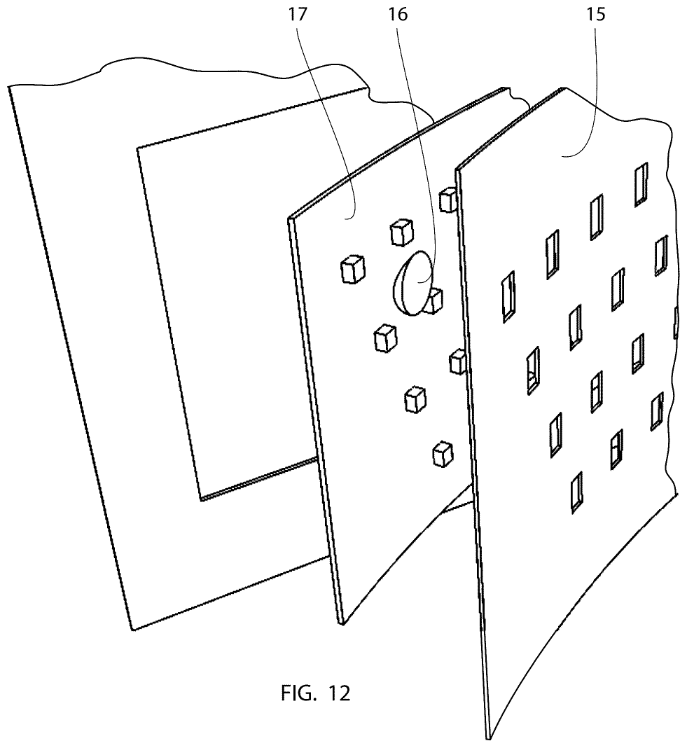

FIG. 12 shows a close up exploded view of a part of the flexible array of light emitters 17, the flexible microlens array 16 and the flexible aperture mask 15.

A section in the middle of the curvature of the back support structure 18, for example 2 mm wide, may be flat, thus a part of the backplane section can remain flat and may be connected to the rest of the backplane without punched cut lines separating it. The backplane may be an active matrix backplane and electrode lines may be routed so they pass through the flat sections of the backplane, hence electrode lines are not cut when the cut lines are punched. The active matrix backplane may be connected to active matrix driver circuitry, for example comprised in the controller 6, so the controller 6 can control a pattern of illuminated microLEDs.

The controller 6 may detect a position of a first eye from the eye tracking system 7 and select and illuminate a corresponding microLED, so a light from a microLED is focused by the lens 13 towards the first eye. Hence a beam is emitted from the directional light emitting element 12 towards the first eye.

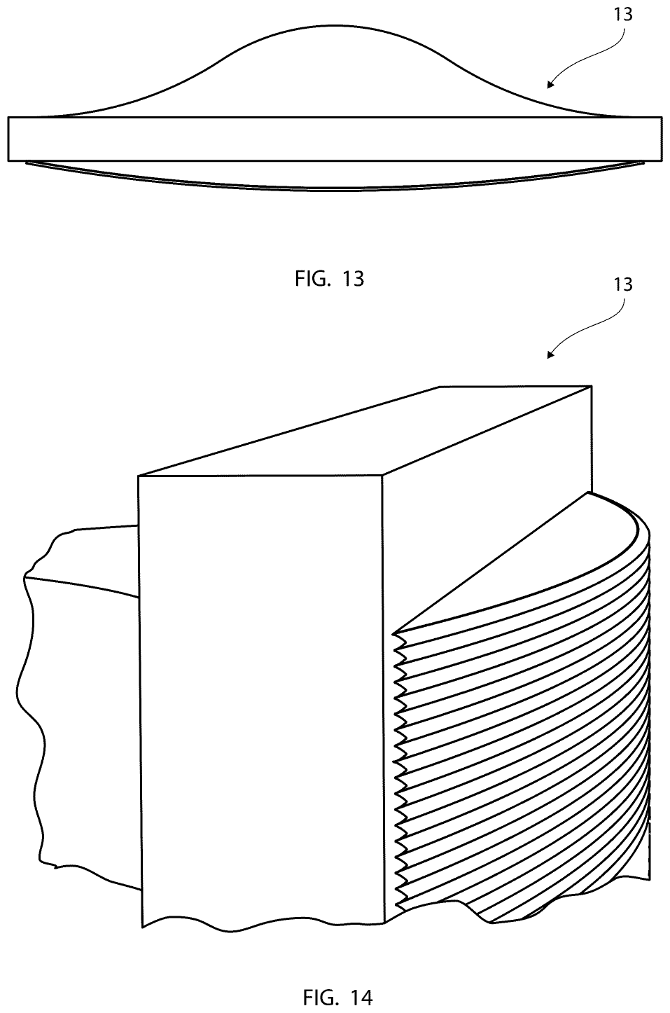

FIG. 13 shows a top view of an example of a configuration of the lens 13.

The lens 13 may be an acylindrical lens of for example molded polymer, for example PMMA. The lens 13 may be for example 18 mm wide and 4 mm high. A lens pitch (center to center distance of lenses) of the backlight module 11 may be for example 20 mm horisontally and 6 mm vertically, hence some space may be allowed for mechanic mounting of lenses. Hence the backlight module 11 may have a periodic structure of 20 mm horizontally and 12 mm vertically, since lenses are arranged in a staggered pattern repeating itself every second row vertically.

FIG. 14 shows a close up perspective view of the lens 13.

The lens 13 may comprise a pattern on the front side (the side facing an observer) which may be configured to perform a diffusion of light in the vertical direction. The pattern may for example be horizontal groves following the lens surface and may for example have a grove shape similar to a sinusoidal shape and may have a pitch of for example 100 micrometer and may have a height (valley to peak) of for example 100 micrometer. Alternatively to a sinusoidal shape, the pattern may have shape optimized for a batwing distribution in the vertical direction of transmitted light. The pattern may be optimized to perform minimum diffusion in the horizontal direction, for example the pattern may be optimized for avoiding light scattering defects caused by injection molding. Such optimization may comprise keeping a radius of the shape in the valleys above a threshold provided by an injection molding facility. The threshold may for example be a radius of minimum 300 micrometer. The lens 13 may be optimized for having a minimum optical power on the front. Thus light arriving at the front side may have a high degree of collimation and the defocusing in a horizontal plane caused by the groves may be minimized.

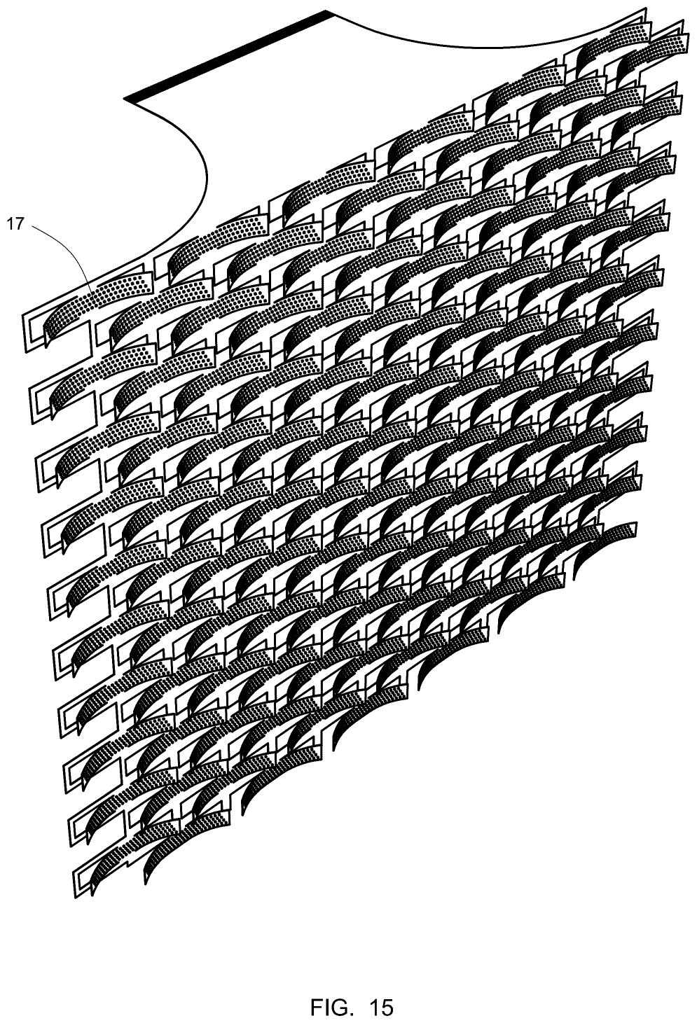

FIG. 15 shows an example of a configuration of the flexible backplane with light microLEDs comprising a plurality of sections of curved arrays of light emitters.

Thin film electrode lines may be routed through the flat areas of the light curved arrays of light emitters and transistors for driving the microLEDs may be comprised, to form an active matrix backplane. An integrated gate driver may be comprised and electrode lines for connecting the active matrix circuits to a source a driver and control logic may be routed on a part of the flexible backplane which may flipped backwards and protrude out on the back through an opening between the backlight module 11 and an adjacent backlight module. The protruding part of the backplane may be connected to a flex wire connector (not shown) which may further be connected to the controller 6.

The transparent display 1 may be updated from for example top to bottom. Updating from top to bottom is the most common operation for active matrix LCD displays. Hence a top part of a displayed image may for example show a recent video frame and a bottom part of the display may show a previous video frame and a band in between may show pixels in the process of transitioning from values corresponding to the previous video frame into values corresponding to the recent video frame. The directional backlight 8 may be updated similarly, i.e. for example from top to bottom, starting with updating arrays of light emitters at the top and ending with updating light emitters at the bottom. Further, arrays of light emitters may be switched off during an interval Tg after updating, where the interval Tg may be corresponding to a pixel transition time, where the pixel transition time may be the time it takes for a pixel after an update has started for it to transition from one value to an updated value. Tg may for example be 0.5 ms and the frame rate may for example be 360 frames per second. Or Tg may for example be 2 ms and the frame rate may be 240 frames per second.

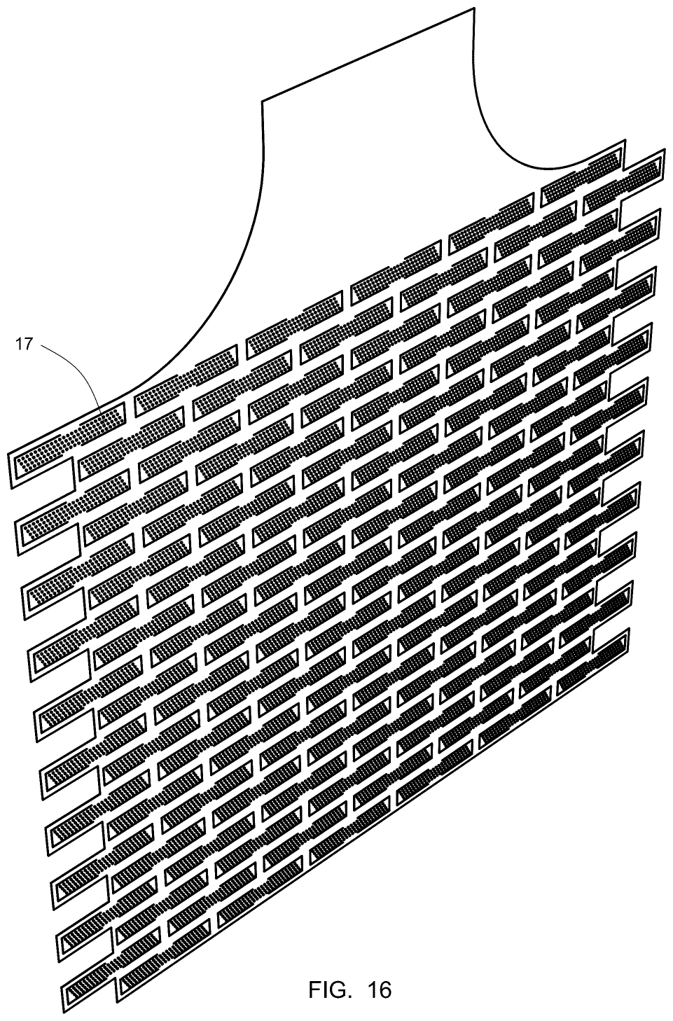

FIG. 16 shows an example of a configuration of the flexible backplane with punched out cut lines before it is mounted in the directional light emitting element 12 and when it is lying flat.

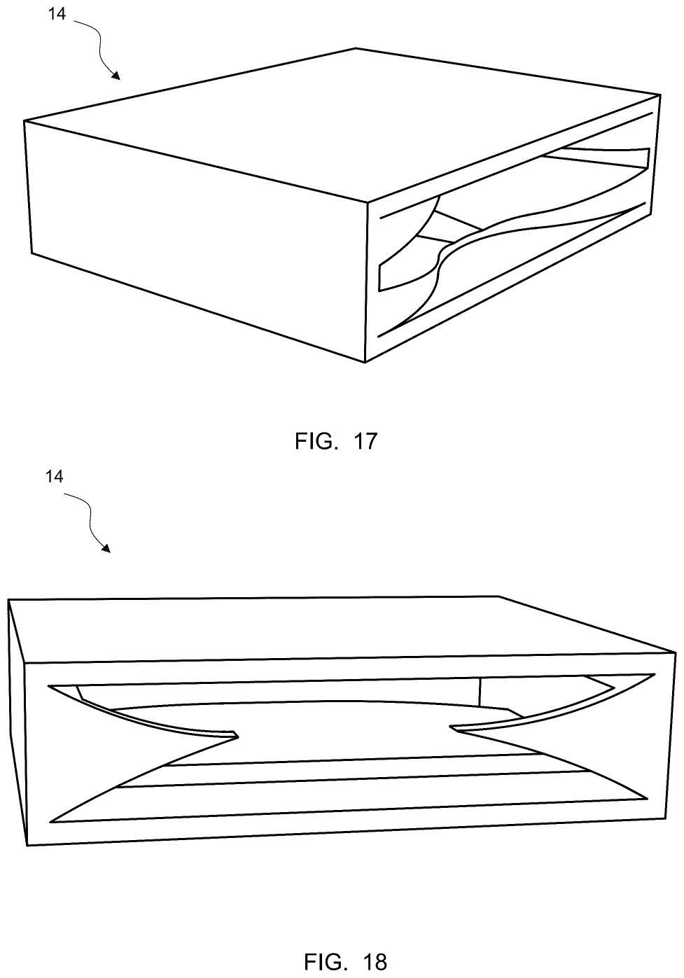

FIG. 17 shows an example of a configuration of the spacer 14.

The spacer 14 may be configured so it has flanges that holds the lens 13 in place at substantially a focal length from a microLED. The flanges may further be configured to act as an aperture opening for the lens 13 which reduces light transmission from the sides of the lens compared to light transmission from a center of the lens, for example by narrowing the openings at the sides of the lens. Hence a more uniform distribution of light emission from the backlight module 11 may be achieved.

FIG. 18 shows an example of an alternative configuration of the spacer 14 where there is not a narrowing of the openings at the sides but instead a tongue-like structure obstructing an increasing part of the light towards sides of the lens 13 relative to towards a center of the lens.

With this configuration an even more uniform distribution of light emission from the backlight module 11 may be achieved.

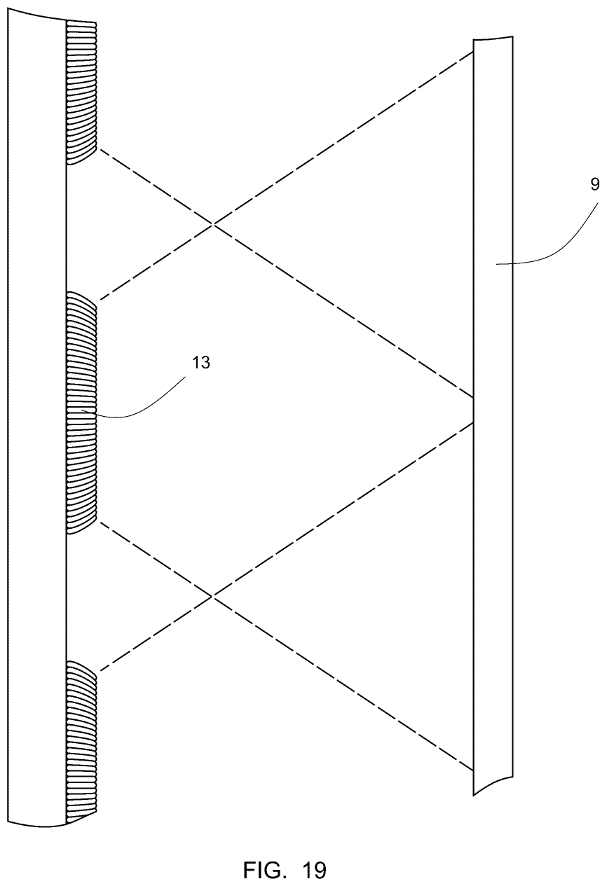

FIG. 19 shows a side view close up of the diffuser 9 and lenses in the staggered pattern (which is not observable in the side view) in the backlight module 11 comprising the lens 13 with boundaries of emitted light beams indicated by dotted lines.

The diffuser 9 may be located for example 20 mm from the lenses. Light beams from a first lens and from a second lens in the same horizontal two rows position beneath the first lens may substantially touch each other with essentially no overlap and the vertical light distribution may be a batwing light distribution, hence light emitted from the diffuser 9 towards an observer may have a good uniformity in the vertical direction. The staggered pattern and the shaped aperture lens openings in the spacers may further result in a relatively good uniformity in the horizontal direction. However, in the horizontal direction the uniformity may be less good and a horizontal pattern, which changes with viewing angle, may be observable.

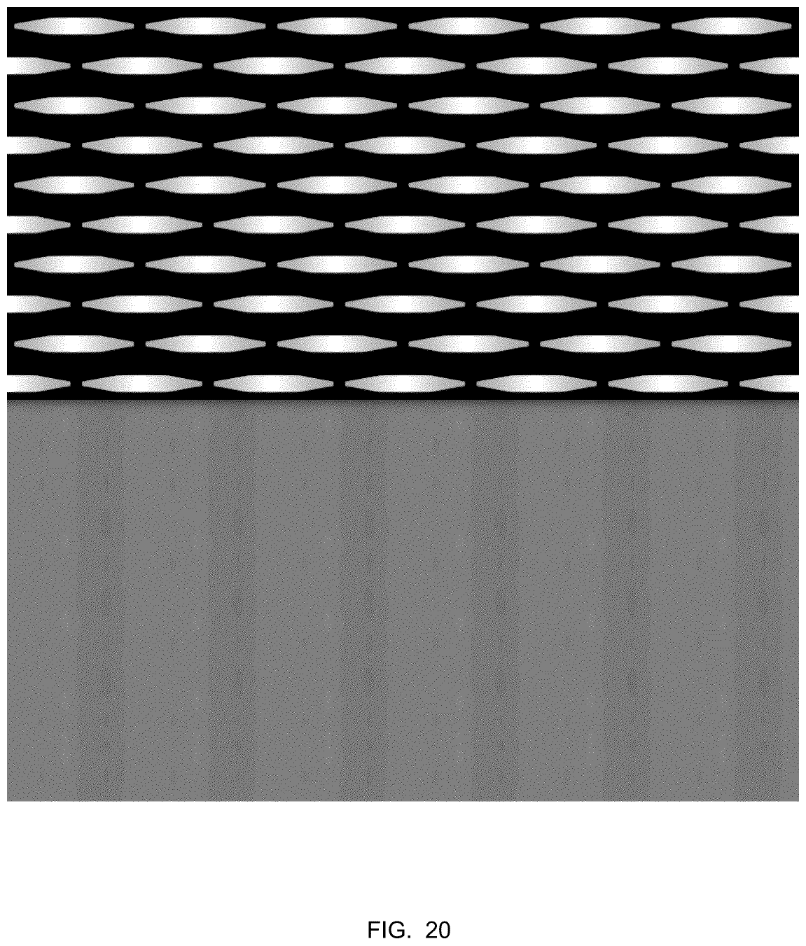

FIG. 20 shows a simulation of how a section of the backlight unit 8 may look to an observer without (top) the diffuser 9 in front of it and with (bottom) the diffuser 9 in front of it.

The vertical uniformity may be quite good, which may be observed as little horizontal structures. The horizontal resolution may be less good, which may be observed as vertical structures, which may be more visible from a steep viewing angle than from an orthogonal viewing angle relative to the display surface.

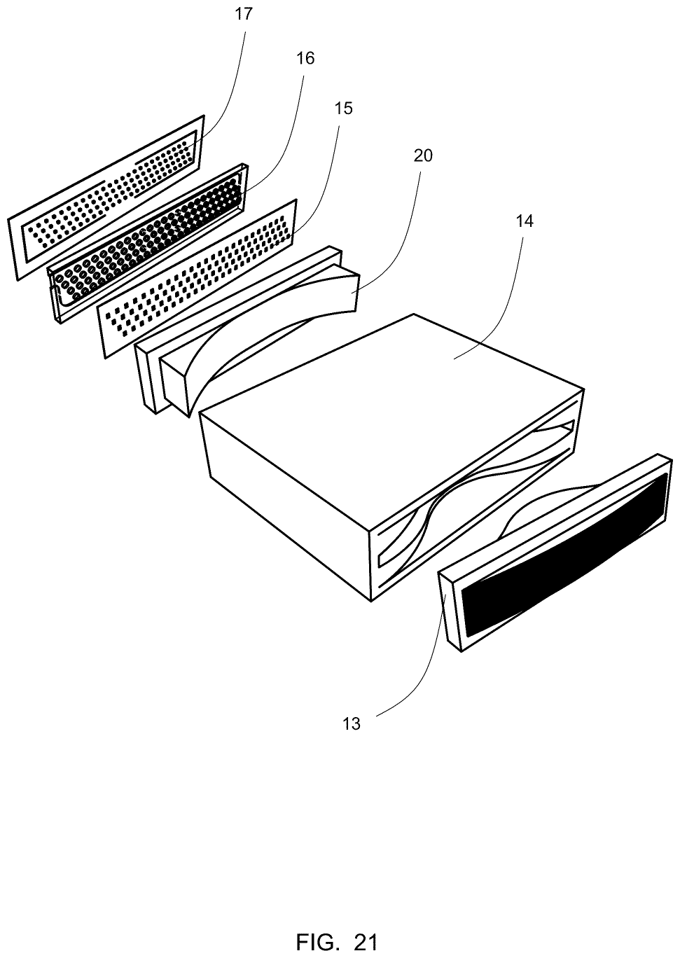

FIG. 21 shows an exploded view of an example of an alternative configuration of the directional light emitting element 12 where the microLED backplane is not curved.

Instead is included a horizontal field flattener 20 which may be an optical element, for example of injection molded PMMA, optimized for focusing light transmitted through the lens 13 from microLEDs on a flat lying backplane. This configuration has the advantage that it may be easier to manufacture the backplane but the disadvantage of having one more optical element.

All optical elements in the description may be antireflex coated as is well known in the art of optics.

As mentioned there may be an observable amount of non-uniformity in the backlight module 11 and hence in the directional backlight 8, especially in the horizontal direction. Therefore when an image is observed on the transparent display 1 illuminated by the directional backlight 8, distracting artifacts may be observed, for example in the form of visible patterns in areas intended to be uniform or having smooth color gradients.

A solution to this problem is disclosed in this description where pixel values are compensated for backlight non-uniformity in an operation comprising a calculation of compensated pixel values using a function taking as inputs a pixel position, for example provided as coordinates of pixel positions in a coordinate system in a plane coinciding with the surface of the transparent display 1, and an observation angle. The observation angle may be an angle between a line going through a pixel and an observing eye with respect to a line normal to the display surface.

The function may for example output a multiplication factor which may be multiplied to an input pixel value resulting in an output pixel value which may be displayed on the display. Alternatively the function may further take as input a pixel value and instead of a multiplication factor it may output the output pixel value.

The function may be implemented as a lookup table, for example having indices pixel position and observation angle. Lookups in the lookup table may use interpolation as is well known in the field of lookup tables.

The lookup table may be created in an operation comprising measuring sets of corresponding values of position in a plane coinciding with the surface of the transparent display 1, observation angle and brightness when the transparent display 1 is set to uniform transparency, for example by setting all pixel values equal (or alternatively measuring corresponding values of position, observation angle and brightness for positions in a plane in front of the directional backlight 8 essentially coinciding with a position for the surface of the display 1 without the transparent display 1 in place but still with the diffuser 9 in place). The corresponding sets of values may be stored as entries in the lookup table. At a measurement, the directional backlight 8 may be directed to emit light in a direction having an emission angle essentially equal to the observation angle.

Alternatively to measuring sets of corresponding values such values may be calculated by a simulation of the directional backlight 8, for example in a ray tracing program or other optical simulation program such as for example Zemax.

Further for an entry E in the lookup table storing a position P, an angle V and a brightness value B, a correction factor C may be calculated and stored. The correction factor C may be calculated by first finding a brightness value Bmin(V) in the lookup table by finding the entry which has the lowest brightness and where V is an angle equal to the angle stored in E and then setting C=Bmin/B.

A pixel in an input image to be displayed may be compensated for the non-uniformity by performing a lookup operation in the lookup table using as input a position on the surface of the transparent display 1 corresponding to the pixel in the input image and further using as input an observation angle, which may be calculated using the position of the pixel in the input image and a position of an observing eye received from the eye tracking system 7 and calculating a correction factor C′, multiplying a value of the pixel in the input image with C′ and transmitting the resulting value to the transparent display 1. The lookup operation may use interpolation, for example weighted interpolation based on input values and nearest table values, of values of C stored in entries in the lookup table to calculate C′, as will be known to a software developer experienced with lookup table operations.

The sets of corresponding values may be provided by measurements or calculations of corresponding values for points in a grid of positions in the plane. The grid may for example have a spacing of 1 mm horizontally and 1 mm vertically or 0.5 mm horizontally and 1 mm vertically. The sets of corresponding values may be measured in a first area of the plane corresponding to a period in a periodic structure of the directional backlight 8, for example the first area may be 20 mm×12 mm, and positions outside of the area may be calculated by adding or subtracting an integer number multiplied by the horizontal period, for example 20 mm, to a horizontal component of a position in a set of corresponding values and adding or subtracting an integer number multiplied by the vertical period, for example 12 mm, to a vertical component of the position. In other words, corresponding values may be measured for points in the first area corresponding to a periodic structure and repeated to cover a second area in a process similar to a step-and-repeat process, for example so the second are essentially corresponds to the surface of the transparent display 1. Alternatively only values measured inside the first area are stored in the lookup table and a position outside the first area may be looked up in the lookup table by determining a position within the first area an integer number of periods away from the position outside the first area in both the horizontal and vertical direction. For example a position outside the first area may be looked up by calculating a modulus of the horizontal position using the horizontal period as divider and a modulus of the vertical position using the vertical period as divider.

The lookup table may be in the form of a set of images, where there is an image corresponding to each measured angle V. The image may store brightness values for pixels references by pixel positions, for example by X and Y indices. Correction factors may be calculated as above and stored in the image, hence the image can be used for compensation by multiplication of non-uniformity errors and may be referenced as an error image.

In other words, a compensation for the non-uniformity may be performed by calculating an error image and perform a multiplication of the error image with an input image, setting a compensated image to the result of this calculation and display the compensated image. The multiplication may comprise multiplying pixel values in the input image with corresponding pixel values in the error image, storing the resulting values in corresponding pixel values in the compensated image and a normalization of the compensated image. The normalization of the compensated image may comprised identifying the highest pixel value in the compensated image and dividing all pixel values in the compensated image with said highest pixel value.

A calculation of an error image may comprise measuring pixel values by illuminating all microLEDs with essentially equal brightness, taking with a camera 21 a captured image of an area of the directional backlight 8 with diffuser 9 located in front of it corresponding to an area covered by the transparent display 1 as seen from the camera 21, scaling the captured image so it has a number of pixel rows and columns essentially equal to the number of pixel rows and columns in the display 1, setting the error image equal to the captured image, calculating the reciprocal of pixel values in the error image and perform a normalization of the error image. The normalization of the captured image may comprise identifying the highest pixel value in the captured image and dividing all pixel values in the captured image with said highest pixel value. Alternatively to using the camera 21 the captured image may be calculated for example using ray tracing and a 3D model of the directional backlight 8. The camera may have a long focal length, for example 300 mm, hence perspective distortions and other distortions may be small and disregarded.

Alternatively to capturing or calculating a captured image of an area of the directional backlight 8 corresponding to an area covered by the transparent display 1 as seen from the camera 21, a subsection of said area may be captured and the error image may be calculated from that subsection. For example the subsection may have a width equal to a horizontal period of a lens pattern in the directional backlight 8 and a height equal to a vertical period of a lens pattern in the directional backlight 8. For example the subsection may have a width of 20 mm and a height of 12 mm. The captured subsection may centered in the area covered by the transparent display 1 horisontally and vertically. This may in practice be done by placing an alignment marker 22 on for example the diffuser 9, capturing an image covering the alignment marker 22, analyzing the image and cut out a section of the image which is inside the alignment marker 22.

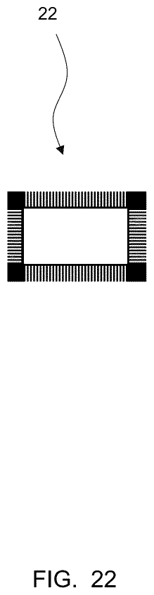

FIG. 22 shows an example of an alignment marker, which has a black frame indicating the border of the subsection which may have a width and height corresponding to a horizontal and vertical pitch of a lens pattern on the directional backlight 8, for example 20 mm wide and 12 mm high.

The alignment marker may further comprise equally spaced lines outside and along the border in the vertical and in the horizontal directions, hence it may be possible to determine perspective—and other distortions and compensate for those in the captured image.

In this configuration the error image may be calculated from the image of the subsection by copying pixel values from the subsection to pixel value storages in other areas in the error image so that a pixel value in the subsection is copied to a pixel value storage located n*X pixel distances offset in the horizontal direction and m*Y pixel distances offset in the vertical direction and repeating this operation until all pixel values in the error image outside the subsection have had pixel values copied to them. For example this may be done by repeating the pixel copy operation for all values of n in a set N of numbers and for all values of m in a set M of numbers, where N may be a set comprising numbers from Nmin to Nmax excluding zero and M may be a set comprising numbers from Mmin to Mmax excluding zero and Nmax may be set to the width of the area covered by the transparent display 1 divided by the width of the subsection and further divided by two and Mmax may be set to the height of the area covered by the transparent display 1 divided by the height of the subsection and further divided by two and Nmin may be set to −Nmax and Mmin may be set to −Mmax.

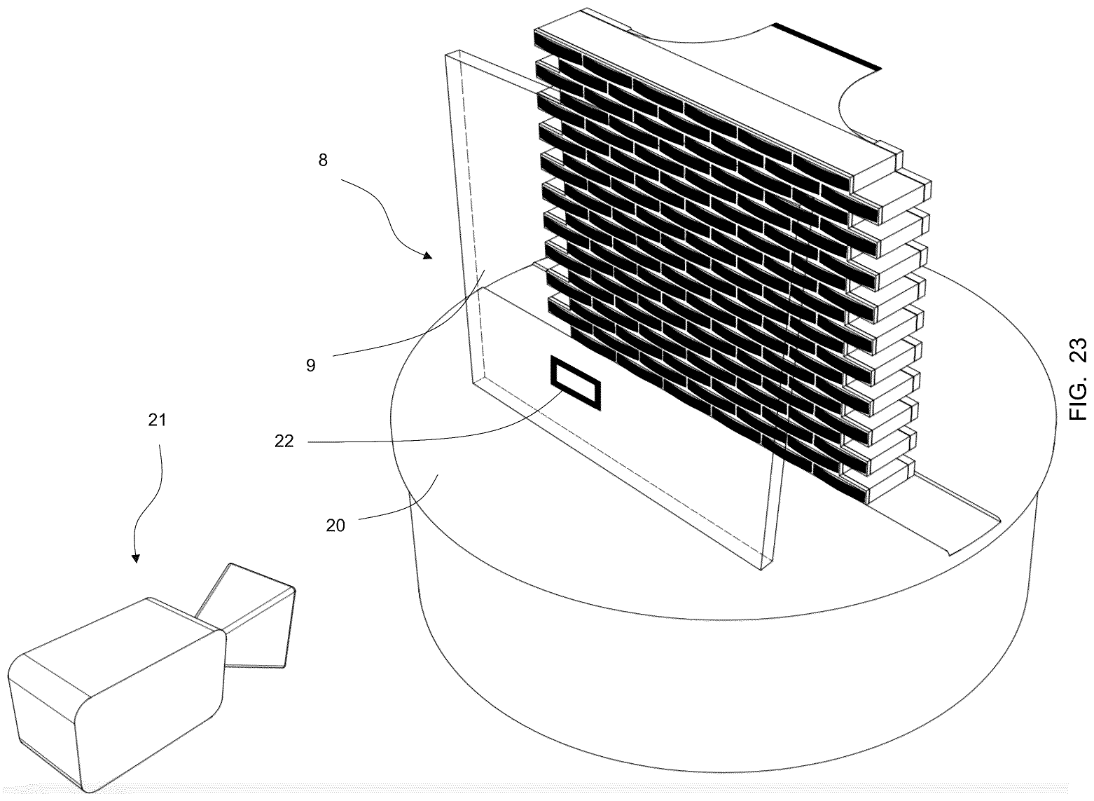

FIG. 23 shows a perspective view of a configuration for capturing a subsection of an area covered by the transparent display 1 as seen from the camera 21.

The diffuser 9 may located in front of the directional backlight 8 for example at a distance of 25 mm. It may be assumed that the diffuser 9 will be laminated onto a backside of the transparent display 1 and hence essentially be located in a same plane as the transparent display 1. The alignment marker 22 may be located on the diffuser 9. For example it may be printed on a transparent sheet and glued or taped to the diffuser in a central location. (In FIG. 23 it shown located a little lower for clarity of the drawing).

The non-uniformity of the directional backlight 8 may be in the form of patterns dependent on the viewing angle, for example vertical stripes of shapes and positions dependent on the viewing angle. Hence the calculated error image may only be valid for an observation angle essentially equal to an observation angle of the camera with respect to a normal of the surface of the transparent display 1 when the captured image was taken.

A solution to this problem is presented, where captured images are taken from different angles of the backlight module 11 with the diffuser 9 located in front of it. The backlight module 11 and the diffuser 9 may be located on a rotatable platform 20 and the camera 21 may be located so it can capture images of the diffuser 9. On the diffuser 9 may be located an alignment marker 22 indicating the subsection. The camera may be located far enough away from the diffuser so it can be assumed that angles from points in the subsection have essentially equal angles towards the camera 21. The rotatable platform may be rotated in steps of for example half a degree, the angle between a line perpendicular to the diffuser and a line from the center of the subsection to the camera 21 may be measured for each step and an image of the subsection may be captured for each step, an error image may be calculated for each captured subsection as described above, and the error image may be stored in an error image table together with the measured angle. The measured angle may be measured by a detector detecting and angle of the rotating platform. Alternatively it may be calculated in a calculation comprising image analysis of the captured image, for example comprising calculation of a distortion of the alignment marker 22.

In this configuration the compensated image to be displayed may be calculated in a calculation comprising receiving a position of an observing eye, calculating for each input pixel in the input image a viewing angle as an angle between a line perpendicular to a surface of the transparent display 1 and a line going through the pixel an the position of the observing eye, finding an error image in the error image table which is has an angle closest to the viewing angle, finding the pixel value of a pixel in the found error image in a corresponding position to the position of the input pixel in the input image and multiplying the found pixel value with the value of the input pixel and storing it in a corresponding position in the compensated image. This operation may be repeated for all pixels in the input image and the resulting output image may be normalized.

The error image table may be created using measurements in a first manufactured instance of the directional backlight 11, for example a prototype, and may be used in calculations of compensated images and displayed on other instances of the directional backlight 11, for example instances in a subsequent production run.

In an alternative configuration sets of pixels having similar viewing angles may be multiplied to corresponding groups of pixels in the error image, where similar viewing angles may be determined by pixel values in a set not varying more than a defined angle threshold, where the angle threshold may be for example 0.5 degree or 0.25 degree.

Another problem associated with using the directional backlight 8 is that it is not possible to achieve a wide horizontal viewing angle of the transparent display 1 by placing a diffuser in front of it diffusing light in a horizontal direction, since this would defocus light intended to be focused towards an observing eye. Instead the directional backlight 8 may need to transmit light through transparent display 1 at steep angles when an eye is observing from a steep angle. A problem associated with transmitting light at steep angles through the transparent display 1 is varying travel distances of light through a liquid crystal layer which may cause image artifacts at steep observation angles, such as wrong colors.

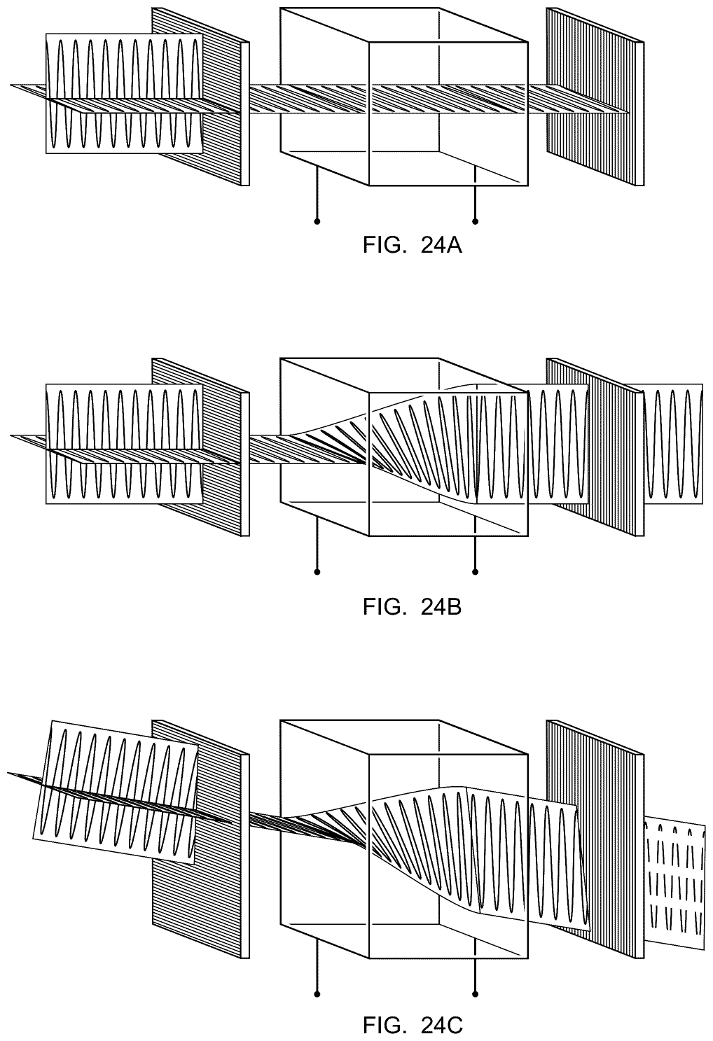

FIG. 24A is a schematic perspective view of a liquid crystal cell 23 located between a first polarizer 24 and a second polarizer 25, where the first polarizer 24 and the second polarizer 25 may be crossed polarizers, i.e. having orthogonal polarization directions.

A pair of electrodes 26 may control the amount of rotation of the polarization direction the liquid crystal cell applies to transmitted light. Light is transmitted from the directional backlight 8 at a normal angle to the liquid crystal cell from a backlight (not shown) behind the first polarizer 24, through the liquid crystal cell 23 and towards the second polarizer 25. FIG. 24A shows the configuration in state where the electrodes are held at a voltage so the liquid crystal cell does not alter the polarization direction of transmitted light, hence light is blocked form being transmitted through the second polarizer 25 and a pixel comprising the liquid crystal cell 23 may appear dark (black).

FIG. 24B shows the configuration of FIG. 24A where the liquid crystal cell is in a state where the electrodes are held at a voltage so the liquid crystals in the liquid crystal cell rotates the polarization direction of transmitted light 90 degrees, when light has travelled a distance through the liquid crystals equal to a width of the liquid crystal cell 23. Hence essentially all light transmitted through the first polarizer 24 is also transmitted through the second polarizer 25 and a pixel comprising the liquid crystal cell 23 may appear bright (white).

FIG. 24B shows the configuration of FIG. 24B in a situation where light is transmitted from the directional backlight 8 at a non-normal angle. In this situation the light is travelling a longer distance through the liquid crystals than in the situation in FIG. 24B and the rotation of the polarization direction of transmitted light is therefore more than 90 degrees an not all light is transmitted through the second polarizer 25, and a pixel comprising the liquid crystal cell 23 may appear less bright (gray).

Hence the optical transmission as a function of voltage over the electrodes, Electro Optical Transfer Function may be a function of an observation angle, and hence a pixel brightness function Bo(Bi,V) for an observed pixel brightness Bo may be a function of an intended pixel brightness Bi and an observation angle V, where Bi may for example be a pixel brightness stored in a digital image representation and V may be an angle between a line orthogonal to a front surface of the transparent display 1 and a line between a pixel comprising the liquid crystal cell and an observing eye. The pixel brightness Bo may be a brightness of a monochrome pixel or of a color subpixel. A value of Bo=1 may correspond to a pixel appearing at maximum brightness (white) and Bo=0 may correspond to a pixel appearing at minimum brightness (black). (It is noted that pixel brightness values may sometimes in practice be stored as values in different intervals and may be scaled to the above interval from 0 to 1 for the subsequent calculations and then scaled back to an original interval).

A characteristic of Bo(Bi,V) may be that when V=0, i.e. when the observing eye is located along a line through the pixel and orthogonal to a front surface of the transparent display 1, then Bo=Bi for V=0 degrees, and when V>0 degrees then Bo may have a maximum at 0<Bi<1.

There are many other types of liquid crystal cells than the one shown in FIGS. 24A-C, some may rotate light more than 90 degrees, some may rotate less than 90 degrees for maximum transmission, some may transmit significantly less than all light transmitted through the cell through the front polarizer 23. Nevertheless many types of liquid crystal cells may exhibit the above described characteristic.

A solution to the problem with image artifacts at steep observation angles may be to create a lookup table of a set of measurements and compensate pixel values in a digitally represented input image using reverse lookups in the lookup table.

The set of measurements may be created by for each angle in a set Set.V of observation angles measuring a set Set.Bo of observed pixel brightnesses of a pixel similar to a pixel in the transparent display 1 as functions of a set Set.Bi of input pixel values. For example the set of observed pixel values may be measured by transmitting white light through an area of the transparent display 1, or a display having a similar characteristic, displaying a set of input images with pixels in the area having pixel values equal to a corresponding set of input pixel values and measuring a brightness value of light transmitted through the area and observed from each angle in the set of observation angles. For example the transparent display 1 may be located on a rotating platform located between a Lambertian source of white light, for example a 5000 kelvin black body light emitter, and a brightness sensor measuring the observed brightness, for example a camera with an electronic image sensor.

Hence a lookup table T of Bo(Bi, V) may be created by entering entries of corresponding measured values Bo, Bi and V in the sets Set.Bo, Set.Bi and Set.V.

A problem is, that for angles V>0 there may exist more than one output value Bo, hence reverse lookups using Bo as index may be ambiguous. To solve this problem domains of the function Bo(Bi, V) may be calculated an stored for entries of V, i.e. for an angle V a range of valid input values of Bi may be calculated. A domain may be calculated by finding a maximum output value Bo, max in Bo(Bi,V) for an angle V and setting the domain to a range from 0 to Bo, max. Domains may be stored in a separate table or may be stored in the lookup table, for example by setting output values corresponding to input values outside of a domain to a value, for example −1, indicating that an output is invalid.

Compensation of an input pixel value in the input image may be performed by calculating an observation angle V for a corresponding pixel in the transparent display 1 using an eye position received from the eye tracking system 7 and doing a reverse lookup in the lookup table, i.e. finding a value for Bi so an output Bo(Bi,V) of the lookup table is essentially equal to the input pixel value. The reverse lookup may be performed using interpolation in the lookup table of output values.

A reverse lookup may be performed by iterating through values of Bi in a domain corresponding to V and finding in the lookup table a first value Bo1(Bi1,V) which is a value closest to and smaller than the input pixel value and a second value Bo2(Bi2,V) which is a value closest to and greater than the input pixel value and an output value Bo may be calculated by interpolating a value between Bo1 and Bo2 for example as an average value or calculated as a weighted average value weighted with respect to Euclidian distance to Bi1 and Bi2.

Alternatively a reverse lookup table with respect to Bo and Bi may be created and compensation of an input pixel value may be performed by a calculation comprising a direct lookup in the reversed lookup table. The reverse lookup table may be calculated in a calculation comprising reverse lookups as described above.

Now follows a first set of items, which constitute aspects of the present invention which may be considered independently patentable and as such the following sets form basis for possible future sets of claims:
1. A method for displaying a stereoscopic image to an observer, said method comprising:
providing a time-division multiplexed autostereoscopic display comprising
a spatial light modulator layer,
said spatial light modulator layer comprising a plurality of light modulators, each light modulator constituting a respective image pixel of said display,
a plurality of optical elements,
said plurality of optical elements arranged such that a respective optical element being behind an image pixel of said display,
each optical element having an optical power,
a backlight,
said backlight comprising a plurality of arrays of light emitters,
said plurality of arrays of light emitters arranged such that a respective array of light emitters being behind an optical element,
providing a tracking system for determining said observer position, and determining a first position of said observer by means of said tracking system, and displaying a first image to the right eye and a second image to the left eye of said observer at said first position by means of said time-division multiplexed autostereoscopic display,
a respective image pixel having a first pixel value when displaying said first image,
tracking the position of said observer by means of said tracking system,
each light modulator having a response time of no more than 2 ms such that when said observer having moved to a second position:
displaying a third image to the right eye and a fourth image to the left eye of said observer at said second position by means of said time-division multiplexed autostereoscopic display,
said respective image pixel having a second pixel value when displaying said third image.
2. The method according to any of the preceding items, said second pixel value reached within a time window, said time window being 4 ms,
said first pixel value defining a first light transmission percentage of a maximum light transmission,
said second pixel value defining a second light transmission percentage of a maximum light transmission,
said second light transmission percentage being more than 60 percentage points different from said first light transmission percentage,
said second pixel value reached within said time window when said second pixel value being greater than said first pixel value and when said second pixel value being smaller than said first pixel value.
3. A method for displaying an image to an observer by means of a display, said method comprising:
providing said display comprising
a directional backlight,
a spatial light modulator layer in front of said backlight,
said spatial light modulator layer comprising a plurality of light modulators, each light-modulator constituting a respective image pixel of said display,
providing a tracking system for determining said observer position, and determining said observer position by means of said tracking system,
adjusting a pixel value for a respective image pixel as a function of said observer position for correcting a spatial uniformity error as light from said directional backlight propagates through said display at an angle different to the normal of said display, and
displaying said image by means of said display.
4. The method according to any of the preceding items, comprising adjusting a pixel value for a respective image pixel as a function of the position of said respective image pixel in said grid of image pixels.
5. The method according to any of the preceding items, said pixel value adjusted by multiplying said pixel value with a multiplication factor.
6. The method according to any of the preceding items, said multiplication factor being a function of said spatial uniformity error for said respective image pixel.
7. The method according to any of the preceding items, comprising capturing a set of photographs at angles relative to the normal of said display of said directional backlight or of a uniform image on said display for determining said spatial uniformity error.
8. The method according to any of the preceding items, said set of photographs captured at a distance to said display such that the observations angles to the image pixels of said display being substantially equal.
9. The method according to item 8, said distance being such that the maximum observation angle and the minimum observation angle not differing from each other with more than 3 degrees.
10. The method according to any of the preceding items, comprising simulating said directional backlight for determining said spatial uniformity error preferably by means of either ray tracing or electromagnetic wave propagation.
11. The method according to any of the preceding items, comprising determining a simulated set of photographs for determining said spatial uniformity error.
12. The method according to any of the preceding items, comprising determining a set of error photographs as a function of said set of photographs or said set of simulated set of photographs,
a respective error photograph defining an image error for each pixel.
13. The method according to any of the preceding items, comprising
determining an adjustment to be applied to each pixel value for each image pixel as a function of said spatial uniformity error determined by said set of photographs or said simulation or said set of error photographs.
14. The method according to any of the preceding items, said display having a memory including pairs of observation angles and image pixel positions,
each pair comprising a respective observation angle and a respective image pixel position and pointing to an adjustment value for adjusting said pixel value for the image pixel having said respective image pixel position.
15. The method according to any of the preceding items, said display having a memory including a set of observations angles, each observation angle pointing to an error photograph, and adjusting the pixel values of said image with the pixel values of said error photograph.
16. The method according to any of the preceding items, comprising normalizing an adjusted image preferably by dividing the pixel value of each pixel of said adjusted image by the highest pixel value of said adjusted image.
17. The method according to any of the preceding items, said display having a memory including a function for determining an adjustment for adjusting said pixel value as a function of said observation angle and image pixel position.
18. The method according to any of the preceding items, said adjustment being an adjustment value such as a multiplication factor.
19. The method according to any of the preceding items, comprising selecting a first photograph from said set of photographs or a first simulated photograph from said set of simulated set of photographs and adjusting said image by means of said first photograph or said first simulated photographs.
20. A method for displaying an image to an observer by means of a display, said method comprising:
providing said display, said display comprising:
image pixels for generating said image,
pixel drivers for controlling said image pixels,
data lines for transmitting light intensity values to said pixel drivers,
said light intensity values representing said image,
scan lines for updating said pixel drivers such that said light intensity values being written into said pixel drivers,
said scan lines comprising a first set of scan lines and a second set of scan lines,
said first set of scan lines including a first scan line and a second scan line,
said first scan line connected to a first set of pixel drivers and said second scan line connected to a second set of pixel drivers,
said first set of pixel drivers comprising a first pixel driver for driving a first image pixel and said second set of pixel drivers comprising a second pixel driver for driving a second image pixel,
scanning said pixel drivers for generating said image such that
said first set of pixels drivers and said second set of pixel drivers being updated collectively within a time window by means of a first scan signal at said first scan line and a second scan signal at said second scan line such that said first image pixel and said second image pixel being updated with substantially the same light intensity value constituting a pixel merging, and such that
each scan line of said second set of scan lines updating pixel drivers connected to each respective scan line during different time windows such that the image pixels controlled by pixel drivers connected to a respective scan line of said second set of scan lines having no pixel merging with other image pixels.
21. A method for displaying an image to an observer by means of a display, said method comprising:
providing said display, said display comprising:
image pixels for generating said image,
pixel drivers for controlling said image pixels,
data lines for transmitting light intensity values to said pixel drivers,
said light intensity values representing said image,
scan lines for updating said pixel drivers such that said light intensity values being written into said pixel drivers,
said scan lines comprising a first set of scan lines and a second set of scan lines,
said first set of scan lines including a first scan line and a second scan line,
said first scan line connected to a first set of pixel drivers and said second scan line connected to a second set of pixel drivers,
said first set of pixel drivers comprising a first pixel driver for driving a first image pixel and said second set of pixel drivers comprising a second pixel driver for driving a second image pixel,
analyzing said image for determining a first line of pixels and a second line of pixels to be merged such that said first line of pixels and said second line of pixels being substantially identical, and
scanning said pixel drivers for generating said image such that
said first set of pixels drivers and said second set of pixel drivers being updated collectively within a time window by means of a first scan signal at said first scan line and a second scan signal at said second scan line
such that said
first set of pixel drivers and said second set of pixel drivers being updated with the light intensity values of said first line of pixels or said second line of pixels.
22. The method according to any of the preceding items, said observer being a moving observer or said observer observing said display from an observer position having an observation angle to each of the image pixels of said display.
23. The method according to any of the preceding items, a respective observation angle being constituted by the figure formed by the normal to said display and the line between said observer and a respective image pixel.
24. The method according to any of the preceding items, said plurality of light modulators arranged in a grid.
25. The method according to any of the preceding items, comprising determining an observation angle for each image pixel as a function of said observer position.
26. The method according to any of the preceding items, comprising
determining the distance between said observer and said display by means of said tracking system.
27. The method according to any of the preceding items, comprising scanning said pixel drivers for generating said image such that each scan line of said second set of scan lines updating pixel drivers connected to each respective scan line during different time windows such that the image pixels controlled by pixel drivers connected to a respective scan line of said second set of scan lines having no pixel merging with other image pixels.
28. The method according to any of the preceding items, the light intensity values of said first set of pixel drivers constituting a first set of light intensity values, and the light intensity values of said second set of pixel drivers constituting a second set of light intensity values, and
said first set of pixel drivers and said second set of pixel drivers being scanned within said time window such that said first set of light intensity values and said second set of light intensity values being substantially equal.
29. The method according to any of the preceding items, said display comprising a control circuit for controlling said display and outputting said light intensity values on said data lines and outputting scan signals on said scan lines.
30. The method according to any of the preceding items, said image pixels arranged in a grid.
31. The method according to any of the preceding items, said scanning comprising switching the pixel drivers connected to a respective scan line sequentially.
32. The method according to any of the preceding items, a respective time window of said time windows constituting a time interval within a clock cycle.
33. The method according to any of the preceding items, each image pixel comprising a light emitter or a spatial light modulator for modulating light emitted from a backlight.
34. The method according to any of the preceding items, comprising providing a backlight including backlight emitters for emitting light, said backlight constituting a directional backlight having a plurality of backlight emitters for each image pixel, each backlight emitter for each image pixel defining a direction or angle towards a viewpoint in front of said display.
35. The method according to any of the preceding items, each pixel driver comprising a switch such as a transistor, said switch being switched by a scan signal on the scan line connected to said switch for writing a light intensity value into said pixel driver from a data line connected to said switch.
36. The method according to any of the preceding items, each pixel driver comprising a capacitor such as a line capacitor or the capacitance of the respective spatial light modulator connected to said respective pixel driver for storing a light intensity value.
37. The method according to any of the preceding items, comprising determining an area of interest in said image such as a face or moving object or body or animal, said area of interest preferably constituting an object in the foreground of said image.
38. The method according to any of the preceding items, comprising analyzing said image by means of said control circuit for determining when two lines of pixels in said image differing by more than a first threshold such as 50% or less than 25%.
39. The method according to item 38, said two lines of pixels constituting an area of interest.
40. The method according to any of the preceding items, said area of interest constituting an area equivalent to a Golden Cut.
41. The method according to any of the preceding items, said area of interest selected by determining an object of interest and selecting the area of interest so it comprises the object of interest.
42. The method according to any of the preceding items, said first scan line and said second scan line positioned along an edge of said display such as the top or bottom of said display.
43. The method according to any of the preceding items, said first scan line and said second scan line selected by means of said control circuit as a function of said image.
44. The method according to any of the preceding items, said first scan line and said second scan line selected such that said first scan line and said second scan line located outside said area of interest.
45. The method according to any of the preceding items, comprising analyzing said image by means of said control circuit for determining when two lines of pixels in said image differing by less than a second threshold such as 50% or less than 25%.
46. The method according to item 45, scanning said pixel drivers such that said two lines of pixels being merged.
47. The method according to item 45, when two lines of pixels in said image differing by less than said second threshold, the light intensity values of the pixels of one of said two lines of pixels being copied into the other for example during scanning of pixel drivers.
48. The method according to any of the preceding items, said analyzing comprising determining the light intensity values of the pixels values of said two lines, or determining a visual similarity between said two lines.
49. The method according to any of the preceding items, said two lines being adjacent to each other.
50. The method according to any of the preceding items, said display having a framerate defining the number of images displayed per second, and a frame window defining the time from the start of a first frame to the start of a subsequent frame, said framerate preferably being variable.
51. The method according to any of the preceding items, said display having a multiplexing cycle defining a time interval equal to a frame window multiplied with the number of observing eyes viewing images on said display.
52. The method according to any of the preceding items, said frame rate being a function of the number of observers or the number of viewpoints said image is to be displayed at, a viewpoint defining a point in space in front of said display.
53. The method according to any of the preceding items, comprising defining a framerate and a frame rate threshold, and
scanning said pixel drivers such that two lines of pixels being merged when said framerate being higher than said framerate threshold,
said framerate threshold preferably being 240 frames per second.
54. The method according to any of the preceding items, said image comprising a flag such as a binary value defining when a line of pixels should be equal to an adjacent line of pixels when said image being displayed.
55. The method according to any of the preceding items where the display is capable of reading the flag and duplicating a row to a next row if the flag stores the value true
56. The method according to any of the preceding items, said flag stored in a pixel value memory in said image.
57. The method according to any of the preceding items, said display comprising a gate driver for controlling a scan line, and said flag being read by said gate driver.
58. The method according to item 51, comprising displaying a first image and a second image within said time interval, and
scanning said pixel drivers such that
for said first image a first number of pixel lines being merged and for said second image a second number of pixel lines being merged,
the sum of said first number and said second number not differing with more than 25% or 0% in the subsequent time interval.
59. The method according to any of the preceding items, said first number and said second number being different.
60. The method according to any of the preceding items, said first image and said second image constituting a stereoscopic image pair, and
for said first image scanning said pixel drivers such that
said first image being displayed having two adjacent pixel lines being merged, and positioned at a first position, and
for said second image scanning said pixel drivers such that
said second image being displayed having no merged pixel lines at a position corresponding to said first position.
61. A method for minimizing an offset DC voltage across a liquid-crystal pixel cell over time in an auto-stereoscopic or multi-view display, said method comprising:
providing said auto-stereoscopic or multi-view display,
displaying a first image by means of said auto-stereoscopic or multi-view display at a first viewing region,
displaying a second image by means of said auto-stereoscopic or multi-view display at a second viewing region,
said auto-stereoscopic or multi-view display having a voltage across said liquid-crystal pixel cell with a first polarity when said first image and said second image being displayed,
displaying a third image by means of said auto-stereoscopic or multi-view display at said first viewing region,
displaying a fourth image by means of said auto-stereoscopic or multi-view display at said second viewing region,
said auto-stereoscopic or multi-view display having a voltage across said liquid-crystal pixel cell with a second polarity when said third image and said fourth image being displayed, said first polarity being different from said second polarity.
62. The method according to any of the preceding items, said first viewing region being different from said second viewing region.
63. The method according to any of the preceding items, said auto-stereoscopic or multi-view display comprising a lens layer or aperture layer for directing said first image to said first viewing region.
64. The method according to any of the preceding items, said auto-stereoscopic or multi-view display being a time-multiplexed display.
65. The method according to any of the preceding items, said second polarity constituting a polarity being the opposite of said first polarity.
66. The method according to any of the preceding items, said second image displayed after said first image.
67. The method according to any of the preceding items, said third image displayed after said second image.
68. The method according to any of the preceding items, said fourth image displayed after said third image.
69. The method according to any of the preceding items, said first image and said second image constituting a stereoscopic image pair
such that said observer perceives a depth in the scene defined by said stereoscopic image pair.
70. A display for displaying an image to an observer,
said observer observing said display from an observer position,
said display comprising:
a directional backlight,
a spatial light modulator layer in front of said backlight,
said spatial light modulator layer comprising a plurality of light modulators, each light modulator constituting a respective image pixel of said display,
a first optical diffuser for diffusing light from said display.
71. The display according to any of the preceding items, said first optical diffuser having a higher degree of diffusion in the vertical direction than in the horizontal direction.
72. The display according to any of the preceding items, said first optical diffuser arranged for diffusing with a beam diversion of no more than 5 degrees such as 2 degrees in the horizontal direction.
73. The display according to any of the preceding items, said first diffuser arranged between said directional backlight and said spatial light modulator layer.
74. The display according to any of the preceding items, comprising a second diffuser for diffusing light from said display.
75. The display according to any of the preceding items, said second diffuser arranged on the side of said spatial light modulator layer facing said observer
76. The display according to any of the preceding items, said second diffuser arranged on the other side of said spatial light modulator layer facing than said first diffuser.
77. The display according to any of the preceding items, said second optical diffuser having a higher degree of diffusion in the vertical direction than in the horizontal direction.
78. The display according to any of the preceding items, said second optical diffuser arranged for diffusing with a beam diversion of no more than 5 degrees such as 2 degrees in the horizontal direction.
79. The display according to any of the preceding items, comprising a plurality of optical elements,
said plurality of optical elements arranged such that a respective optical element being behind an image pixel of said display,
each optical element having an optical power for focusing light in a horizontal direction.
80. A display for displaying an image to an observer,
said observer observing said display from an observer position,
said display comprising:
a spatial light modulator layer,
said spatial light modulator layer comprising a plurality of light modulators, each light modulator constituting a respective image pixel of said display,
a plurality of optical elements,
said plurality of optical elements arranged such that a respective optical element being behind an image pixel of said display,
each optical element having an optical power for focusing light in a horizontal direction
a flexible TFT substrate comprising a backlight,
said backlight comprising a plurality of arrays of light emitters,
said plurality of arrays of light emitters arranged such that a respective array of light emitters being behind an optical element,
said optical power defining a field curvature.
81. The display according to any of the preceding items, the part of said flexible TFT substrate supporting a respective array of light emitters being bend for following said field curvature.
82. The display according to any of the preceding items, the light emitters of a respective array of light emitters arranged on a curve.
83. The display according to any of the preceding items, the integral of said curve and the integral of said field curvature not differing with more than 25%.
84. The display according to any of the preceding items, each light emitter of an array of light emitters being a micro LED.
85. The display according to any of the preceding items, each light emitter of an array of light emitters defining an observation angle.
86. The display according to any of the preceding items, each array of light emitters defining a plurality of observation angles.
87. The display according to any of the preceding items, a respective observation angle being constituted by the figure formed by the normal to said display and the line between said observer and a respective image pixel.
88. The display according to any of the preceding items, comprising a spacer such that a respective array of light emitters having a distance to the respective optical element in front of said respective array of light emitters.
89. The display according to any of the preceding items, said distance being in the range 0,5 to 4 cm.
90. The display according to any of the preceding items, each optical element being a cylindrical lens or an acylindrical lens preferably having grooves in the front surface of said cylindrical or acylindrical lens.
91. The display according to any of the preceding items, each optical element having a front surface for focusing light in front of said backlight, said front surface facing said spatial light modulator layer.
92. The display according to any of the preceding items, said front surface having axial symmetry with respect to a vertical axis.
93. The display according to any of the preceding items, said plurality of optical elements arranged in a staggered pattern such that each optical element in a first line of optical element being offset to an adjacent line of optical elements.
94. The display according to any of the preceding items, comprising an array of optical elements in front of each array of light emitters, each optical element having an optical power.
95. The display according to any of the preceding items, comprising an aperture mask in front of each array of light emitters.
96. The display according to any of the preceding items, a respective array of optical elements arranged between a respective array of light emitters and a respective aperture mask.
97. The display according to any of the preceding items, a respective array of optical elements being a micro lens array.
98. The display according to any of the preceding items, said flexible TFT substrate having a flange being bend for connecting data lines to said flexible TFT substrate.
99. The display according to any of the preceding items, the part of said flexible TFT substrate supporting a respective array of light emitters being punched or cut for bending the part of said flexible TFT substrate supporting a respective array of light emitters.
100. The display according to any of the preceding items, a respective array of light emitters comprising lines or rows of light emitters.
101. The display according to any of the preceding items, a respective aperture mask having an array of apertures,
said array of apertures comprising lines or rows of apertures.
102. The display according to any of the preceding items, the apertures in said respective array of apertures aligned with the light emitters of said respective array of light emitters.
103. The display according to any of the preceding items, a right edge of an aperture in a respective line or row of apertures aligned with a left edge of an aperture in a line or row of apertures below said respective line or row of apertures.
104. The display according to any of the preceding items, each optical element being a cylindrical lens.
105. The display according to any of the preceding items, each optical element having a front surface for focusing light in front of said directional backlight,
said front surface facing said spatial light modulator layer.
106. The display according to any of the preceding items, said first optical diffuser arranged at said front surface.
107. The display according to any of the preceding items, said front surface having axial symmetry with respect to a vertical axis
108. The display according to any of the preceding items, a respective optical element being arranged for collimation of light in the horizontal direction at said first optical diffuser.
109. The display according to any of the preceding items, a respective optical element having a back surface, said front surface having a curvature with a greater radius than the curvature of said back surface.
110. The display according to any of the preceding items, said front surface having a pattern in the vertical direction.
111. The display according to any of the preceding items, said front surface comprising ridges or grooves being spaced along the vertical direction, each ridge or groove extending horizontally.
112. The display according to any of the preceding items, said pattern being serrated.
113. The display according to any of the preceding items, said pattern constituting an array of optical elements, each optical element refracting light in the vertical direction.
114. The display according to any of the preceding items, each optical element comprising an optical diffuser arranged at said front surface.
115. The display according to any of the preceding items, said plurality of optical elements arranged in a staggered pattern such that each optical element in a first line of optical element being offset to an adjacent line of optical elements.
116. The display according to any of the preceding items, said directional backlight comprising an array of light emitters.
117. The display according to any of the preceding items, comprising an aperture mask for uniform distribution of said backlight,
said aperture mask arranged between said array of light emitters and said spatial light modulator layer.
118. The display according to any of the preceding items, said aperture mask arranged between said first diffuser and said array of light emitters.
119. The display according to any of the preceding items, said aperture mask arranged in front of said first diffuser.
120. The display according to any of the preceding items, said aperture mask transmitting more light at the center of a respective optical element that at the side of an optical element.
121. The display according to any of the preceding items, said aperture mask having an oval shaped aperture.
122. The display according to any of the preceding items, said aperture mask being tinted, the degree of tint at the center of a respective optical element being smaller that at the side of an optical element.

1.-15. (canceled)

16. A method for displaying an image to a moving observer via a display, the observer being positioned in front of the display, the method comprising:
providing the display comprising:
a backlight including a plurality of light emitting diodes (LEDs),
a spatial light modulator layer in front of the backlight, the spatial light modulator layer comprising a plurality of light modulators;
providing a tracking system for determining the observer position, and determining the observer position by means of the tracking system;
adjusting a pixel value for a respective image pixel as a function of the observer position for correcting a spatial uniformity error as light from the backlight propagates through the display at an angle different to a normal of the display; and
displaying the image by means of the display.

17. The method according to claim 16, further comprising adjusting a pixel value for a respective image pixel as a function of a position of the respective image pixel in a grid of image pixels.

18. The method according to claim 16, wherein the pixel value is adjusted by multiplying the pixel value with a multiplication factor.

19. The method according to claim 18, wherein the multiplication factor is a function of the spatial uniformity error for the respective image pixel.

20. The method according to claim 16, further comprising capturing a set of photographs at angles relative to the normal of the display of the backlight or of a uniform image on the display for determining the spatial uniformity error.

21. The method according to claim 20, wherein the set of photographs are captured at a distance to the display such that observation angles to the image pixels of the display are substantially equal.

22. The method according to claim 21, wherein the distance is such that a maximum observation angle and a minimum observation angle differ from each other with less than or equal to 3 degrees.

23. The method according to claim 16, further comprising simulating the backlight for determining the spatial uniformity error preferably by means of either ray tracing or electromagnetic wave propagation.

24. The method according to claim 16, further comprising determining a simulated set of photographs for determining the spatial uniformity error.

25. The method according to claim 16, further comprising determining a set of error photographs as a function of a set of photographs or a simulated set of photographs, a respective error photograph defining an image error for each pixel.

26. The method according to claim 25, further comprising:
determining an adjustment to be applied to each pixel value for each image pixel as a function of the spatial uniformity error determined by the set of photographs or the simulated set of photographs or the set of error photographs.

27. The method according to claim 16, wherein the display comprises a memory including pairs of observation angles and image pixel positions, each pair comprising a respective observation angle and a respective image pixel position and pointing to an adjustment value for adjusting the pixel value for the image pixel having the respective image pixel position.

28. The method according to claim 16, wherein the display comprises a memory including a set of observations angles, each observation angle pointing to an error photograph, and adjusting the pixel values of the image with the pixel values of the error photograph.

29. The method according to claim 16, comprising normalizing an adjusted image by dividing the pixel value of each pixel of the adjusted image by a highest pixel value of the adjusted image.

30. The method according to claim 16, wherein the display comprises a memory including a function for determining an adjustment for adjusting the pixel value as a function of an observation angle and image pixel position.

31. The method according to claim 30, wherein the adjustment is a multiplication factor.

32. The method according to claim 16, further comprising selecting a first photograph from a set of photographs or a first simulated photograph from a simulated set of photographs and adjusting the image by means of the first photograph or the first simulated photograph.

33. A display for displaying an image to an observer, the observer observing the display from an observer position, the display comprising:
a backlight including a plurality of LEDs;
a spatial light modulator layer in front of the backlight, the spatial light modulator layer comprising a plurality of light modulators, each light modulator constituting a respective image pixel of the display; and
a first optical diffuser for diffusing light from the display.

34. The display according to claim 33, wherein the first optical diffuser comprises a higher degree of diffusion in a vertical direction than in a horizontal direction.

35. The display according to claim 33, wherein the first optical diffuser is arranged for diffusing with a beam diversion of no more than 5 degrees such as 2 degrees in a horizontal direction.

36. The display according to claim 33, wherein the first optical diffuser is arranged between the backlight and the spatial light modulator layer.

37. The display according to claim 33, further comprising a second optical diffuser for diffusing light from the display.

38. The display according to claim 37, wherein the second optical diffuser is arranged on the side of the spatial light modulator layer facing the observer.

39. The display according to claim 37, wherein the second optical diffuser is arranged on the other side of the spatial light modulator layer facing than the first optical diffuser.

40. The display according to claim 37, wherein the second optical diffuser comprises a higher degree of diffusion in a vertical direction than in a horizontal direction.

41. The display according to claim 37, wherein the second optical diffuser is arranged for diffusing with a beam diversion of no more than 5 degrees such as 2 degrees in a horizontal direction.
